(19) United States
(12) Patent Application Publication
(10) Pub. No.: US 2024/0315258 A1
(43) Pub. Date: Sep. 26, 2024

(54) MICROALGAE AND BACTERIA-BASED PLANT NUTRITION COMPOSITIONS

(71) Applicant: AE Agribiologicals S.L., Madrid (ES)

(72) Inventors: Carmela Perez CALLEJA, Oviedo (ES); Douglas Ry WAGNER, Pleasant Hill, OR (US)

(21) Appl. No.: 18/673,146

(22) Filed: May 23, 2024

Related U.S. Application Data
(63) Continuation of application No. PCT/EP2022/083065, filed on Nov. 23, 2022.
(60) Provisional application No. 63/283,178, filed on Nov. 24, 2021.

(51) Int. Cl. A01N 65/03; A01N 25/02; A01N 25/06; A01N 25/08; A01N 25/12; A01N 63/20; A01N 63/22; A01N 63/25; A01N 63/27; A01N 63/30; A01N 63/32; A01P 21/00; C05F 11/08

(52) U.S. Cl. CPC A01N 65/03; A01N 25/02; A01N 25/06; A01N 25/08; A01N 25/12; A01N 63/20; A01N 63/22; A01N 63/25; A01N 63/27; A01N 63/30; A01N 63/32; A01P 21/00; C05F 11/08

(57) ABSTRACT

The present disclosure provides agricultural compositions for use in improving one or more growing parameters, production parameters, and/or biostimulant parameters of a host plant, e.g., an agricultural crop. The agricultural compositions comprise the cell free supernatant of a microbial culture along with microalgae-derived components and/or mycorrhizal fungi.

### CROSS-REFERENCE TO RELATED APPLICATIONS

This application claims the benefit of and priority to U.S. Provisional Patent Application No. 63/283,178, filed on Nov. 24, 2021, the contents of which are herein incorporated by reference in their entirety.

### FIELD OF THE DISCLOSURE

The present disclosure relates to agricultural compositions for use in improving one or more growing parameters, production parameters, and/or biostimulant parameters of a host plant, e.g., an agricultural crop. The agricultural compositions comprise the cell free supernatant of a microbial culture along with microalgae-derived components and/or mycorrhizal fungi.

### BACKGROUND

With ever-increasing demands for the production of food crops, a growing global concern is the ability to produce sufficient volumes and quality of food to meet the needs of increasing populations sustainably and efficiently. To meet these demands, intensive agricultural practices to date have included the use of high-yielding, disease-resistant crop varieties, and the constant input of agrochemicals such as chemical fertilizers and pesticides. The application of such chemicals can adversely affect the dynamic equilibrium of the soil, detriment the environment, and decrease agricultural biodiversity by destroying useful microorganisms that provide critical nutrition and active natural compounds to promote crop growth and development.

There is a growing and unmet need for powerful, sustainable solutions for improving agricultural crop performance.

### BRIEF SUMMARY

In one aspect, the present disclosure provides an agricultural composition comprising: a) microalgae; and b) a cell free supernatant (“CFS”) of a microbial culture.

In one aspect, the present disclosure provides an agricultural composition comprising: a) a cell free supernatant (“CFS”) of a microbial culture; and b) mycorrhizae.

In one aspect, the present disclosure provides an agricultural composition comprising: a) microalgae; b) a cell free supernatant (“CFS”) of a microbial culture; and c) mycorrhizae.

In some embodiments, the composition comprises multiple species of microalgae.

In some embodiments, the composition comprises microalgae from a phylum selected from the list consisting of: Chlorophyta, Cryptophyta, Cyanophyta, Euglenophyta, Heterokontophyta, or Rhodophyta.

In some embodiments, the composition comprises microalgae from a genus selected from the list consisting of: Chlorella, Scenedesmus, Nannochloropsis, Muriellopsis, Isochrysis, Tisochrysis, Desmodesmus, Haematococcus, Arthrospira, and Anabaena.

In some embodiments, the microalgae are dried, lysed, and/or digested.

In some embodiments, the composition comprises microalgae in the form of a digested microalgae solution (“DMS”) or whole-cell microalgae powder.

In some embodiments, the composition comprises about 0.8-20 g/L of whole-cell microalgae powder.

In some embodiments, the composition comprises microalgae in the form of DMS, and wherein the composition comprises about 0.05-0.5% v/v DMS.

In some embodiments, the composition comprises about 0.005-0.05% w/w microalgae dry matter.

In some embodiments, the composition comprises microalgae in the form of DMS, and wherein the ratio of DMS to CFS is between 1:4 and 4:1.

In some embodiments, the composition comprises microalgae in the form of DMS, wherein the ratio of DMS to CFS is between 1:4 and 4:1, and wherein the composition comprises the combination of DMS and CFS diluted to 0.3-0.5% v/v in water.

In some embodiments, the composition comprises microalgae in the form of DMS, and wherein the ratio of DMS to CFS is 1:4 or 2:3.

In some embodiments, the composition comprises about 0.5-5.0% w/w of DMS.

In some embodiments, the composition comprises about 0.05-0.5% w/w of microalgae dry matter.

In some embodiments, the CFS is the isolated CFS of a mixed microbial culture comprising one or more microorganisms selected from the list consisting of: Aspergillus spp., Bacillus spp., Rhodopseudomonas spp., Candida spp., Lactobacillus spp., Lactococcus spp., Pseudomonas spp., Saccharomyces spp., Streptococcus spp., and combinations thereof.

In some embodiments, the CFS is the isolated CFS of a mixed microbial culture obtained from culturing IN-M1, deposited under ATCC Accession No. PTA-12383, or IN-M2, deposited under ATCC Accession No. PTA-121556.

In some embodiments, the CFS comprises at least 2500 micrograms potassium per gram, at least 435 micrograms nitrogen per gram, at least 475 micrograms calcium per gram, and/or at least 200 micrograms magnesium per gram.

In some embodiments, the CFS comprises a CFS of a mixed microbial culture that has been diluted between 1:50 and 1:2000 with water.

In some embodiments, the CFS comprises about 2% dry matter.

In some embodiments, the composition comprises about 0.005-0.05% w/w CFS dry matter.

In some embodiments, the composition comprises about 0.5-5.0% w/w CFS.

In some embodiments, the mycorrhizae comprise a combination of ectomycorrhizae and endomycorrhizae.

In some embodiments, the mycorrhizae comprise predominantly endomycorrhizae.

In some embodiments, the mycorrhizae comprise more than about 90% endomycorrhizae.

In some embodiments, the composition comprises about 0.5-5.0% mycorrhizae.

In some embodiments, the mycorrhizae comprise 100-10,000 spores/gram.

In some embodiments, the composition comprises 500-500,000 spores of mycorrhizae per kg of composition.

In some embodiments, the composition comprises a diazotrophic bacterium.

In some embodiments, the composition comprises a symbiotic diazotrophic bacterium.

In some embodiments, the composition comprises a bacterium of a genus selected from the list consisting of: Anabaena, Azoarcus, Azorhizobium, Azospirillum, Azotobacter, Bacillus, Bradyrhizobium, Burkholderia, Clostridium, Frankia, Gluconacetobacter, Herbaspirillum, Klebsiella, Mesorhizobium, Nitrosospira, Nostoc, Paenibacillus, Parasponia, Pseudomonas, Rhizobium, Rhodobacter, Sinorhizobium, Spirillum, or Xanthomonus.

In some embodiments, the composition comprises a bacterium of the genus Azospirillum, Bradyrhizobium, or Rhizobium.

In some embodiments, the composition is applied to an agricultural crop.

In some embodiments, the composition is applied to an agricultural crop, wherein the agricultural crop is a monocot or dicot.

In some embodiments, the composition is applied to an agricultural crop selected from the list consisting of agronomical crops, horticultural crops, and ornamental crops.

In some embodiments, application of the composition to an agricultural crop results in an increase in a growth, production, or biostimulant parameter of the agricultural crop in comparison to a control agricultural crop without the composition.

In some embodiments, application of the composition to an agricultural crop results in an increase in a growth, production, or biostimulant parameter of the agricultural crop in comparison to a control agricultural crop without the composition, wherein the parameter is selected from the group consisting of: biomass, aerial biomass, number of roots, root biomass, number of secondary roots, uniformity of flowering, number of flowers, yield, number of fruits, productivity, chlorophyl content, carotenoid profile, antioxidant response capacity, water absorption capacity, nutrient absorption, and degree of inoculation by diazotrophic bacteria.

In some embodiments, the combination of the contents of the composition produces a synergistic improvement on a growth, production, or biostimulant parameter of an agricultural crop after application.

In some embodiments, the combination of the contents of the composition produces an improvement on a growth, production, or biostimulant parameter of an agricultural crop after application thereto, wherein the improvement is greater than that observed for any component alone.

In some embodiments, the composition comprises a carrier.

In some embodiments, the composition comprises a liquid carrier.

In some embodiments, the composition comprises a liquid carrier, and the liquid carrier is water.

In some embodiments, the composition comprises a solid carrier.

In some embodiments, the composition comprises a solid carrier, and wherein the carrier makes up more than 80% of the composition.

In some embodiments, the composition comprises a carrier, and wherein the carrier is a natural clay-based or mineral-based carrier.

In some embodiments, the composition comprises a carrier selected from the group consisting of clay, zeolite, dolomite, bentonite, leonardite, and attapulgite.

In one aspect, the present disclosure provides a method for increasing the yield of an agricultural crop, the method comprising: a) applying the composition of any one of the foregoing embodiments to the agricultural crop.

In one aspect, the present disclosure provides a method for increasing the yield of an agricultural crop, the method comprising: a) applying an agricultural composition to the agricultural crop, the composition comprising i) a cell free supernatant (“CFS”) of a microbial culture; and ii) microalgae and/or mycorrhizae.

In one aspect, the present disclosure provides a method for improving a production, growth, or biostimulant parameter of an agricultural crop, the method comprising: a) applying an agricultural composition to the agricultural crop, the composition comprising i) a cell free supernatant (“CFS”) of a microbial culture; and ii) microalgae and/or mycorrhizae.

In some embodiments, the composition comprises multiple species of microalgae.

In some embodiments, the composition comprises microalgae from a phylum selected from the list consisting of: Chlorophyta, Cryptophyta, Cyanophyta, Euglenophyta, Heterokontophyta, or Rhodophyta.

In some embodiments, the composition comprises microalgae from a genus selected from the list consisting of: Chlorella, Scenedesmus, Nannochloropsis, Muriellopsis, Isochrysis, Tisochrysis, Desmodesmus, Haematococcus, Arthrospira, and Anabaena.

In some embodiments, the microalgae are dried and/or lysed.

In some embodiments, the composition comprises microalgae in the form of a digested microalgae solution (“DMS”) or whole-cell microalgae powder.

In some embodiments, the composition comprises about 0.8-20 g/L of whole-cell microalgae powder.

In some embodiments, the composition comprises microalgae in the form of DMS, and wherein the composition comprises about 0.05-0.5% v/v DMS.

In some embodiments, the composition comprises about 0.005-0.05% w/w microalgae dry matter.

In some embodiments, the composition comprises microalgae in the form of DMS, and wherein the ratio of DMS to CFS is between 1:4 and 4:1.

In some embodiments, the composition comprises microalgae in the form of DMS, wherein the ratio of DMS to CFS is between 1:4 and 4:1, and wherein the composition comprises the combination of DMS and CFS diluted to 0.3-0.5% v/v in water.

In some embodiments, the composition comprises microalgae in the form of DMS, and wherein the ratio of DMS to CFS is 1:4 or 2:3.

In some embodiments, the composition comprises about 0.5-5.0% w/w of DMS.

In some embodiments, the composition comprises about 0.05-0.5% w/w of microalgae dry matter.

In some embodiments, the CFS is the isolated CFS of a mixed microbial culture comprising one or more microorganisms selected from the list consisting of: Aspergillus spp., Bacillus spp., Rhodopseudomonas spp., Candida spp., Lactobacillus spp., Lactococcus spp., Pseudomonas spp., Saccharomyces spp., Streptococcus spp., and combinations thereof.

In some embodiments, the CFS is the isolated CFS of a mixed microbial culture obtained from culturing IN-M1, deposited under ATCC Accession No. PTA-12383, or IN-M2, deposited under ATCC Accession No. PTA-121556.

In some embodiments, the CFS comprises at least 2500 micrograms potassium per gram, at least 435 micrograms nitrogen per gram, at least 475 micrograms calcium per gram, and/or at least 200 micrograms magnesium per gram.

In some embodiments, the CFS comprises a CFS of a mixed microbial culture that has been diluted between 1:50 and 1:2000 with water.

In some embodiments, the CFS comprises about 2% dry matter.

In some embodiments, the composition comprises about 0.005-0.05% w/w CFS dry matter.

In some embodiments, the composition comprises about 0.5-5.0% w/w CFS.

In some embodiments, the mycorrhizae comprise a combination of ectomycorrhizae and endomycorrhizae.

In some embodiments, the mycorrhizae comprise predominantly endomycorrhizae.

In some embodiments, the mycorrhizae comprise more than about 90% endomycorrhizae.

In some embodiments, the composition comprises about 0.5-5.0% mycorrhizae.

In some embodiments, the mycorrhizae comprise 100-10,000 spores/gram.

In some embodiments, the composition comprises 500-500,000 spores of mycorrhizae per kg of composition.

In some embodiments, the composition comprises a diazotrophic bacterium.

In some embodiments, the composition comprises a symbiotic diazotrophic bacterium.

In some embodiments, the composition comprises a bacterium of a genus selected from the list consisting of: Anabaena, Azoarcus, Azorhizobium, Azospirillum, Azotobacter, Bacillus, Bradyrhizobium, Burkholderia, Clostridium, Frankia, Gluconacetobacter, Herbaspirillum, Klebsiella, Mesorhizobium, Nitrosospira, Nostoc, Paenibacillus, Parasponia, Pseudomonas, Rhizobium, Rhodobacter, Sinorhizobium, Spirillum, and Xanthomonus.

In some embodiments, the composition comprises a bacterium of the genus Azospirillum, Bradyrhizobium, or Rhizobium.

In some embodiments, the agricultural crop is a monocot or dicot.

In some embodiments, the agricultural crop is selected from the list consisting of agronomical crops, horticultural crops, and ornamental crops.

In some embodiments, the method results in an increase in a growth, production, or biostimulant parameter of the agricultural crop in comparison to a control agricultural crop without the composition.

In some embodiments, the method results in an increase in a growth, production, or biostimulant parameter of the agricultural crop in comparison to a control agricultural crop without the composition, wherein the parameter is selected from the group consisting of: biomass, aerial biomass, number of roots, root biomass, number of secondary roots, uniformity of flowering, number of flowers, yield, number of fruits, productivity, chlorophyl content, carotenoid profile, antioxidant response capacity, water absorption capacity, nutrient absorption, and degree of inoculation by diazotrophic bacteria.

In some embodiments, the combination of the contents of the composition produces a synergistic improvement on a growth, production, or biostimulant parameter of the agricultural crop.

In some embodiments, the combination of the contents of the composition produces an improvement on a growth, production, or biostimulant parameter of the agricultural crop, and wherein the improvement is greater than that observed for any component alone.

In some embodiments, the composition comprises a carrier.

In some embodiments, the composition comprises a liquid carrier.

In some embodiments, the composition comprises a liquid carrier, and the liquid carrier is water.

In some embodiments, the composition comprises a solid carrier.

In some embodiments, the composition comprises a solid carrier, and wherein the carrier makes up more than 80% of the composition.

In some embodiments, the composition comprises a carrier, and wherein the carrier is a natural clay-based or mineral-based carrier.

In some embodiments, the composition comprises a carrier selected from the group consisting of clay, zeolite, dolomite, bentonite, leonardite, and attapulgite.

In some embodiments, the composition is applied to plant parts of the agricultural crop.

In some embodiments, the composition is applied to plant parts of the agricultural crop, and wherein the plant parts are the seeds, seedlings, plant tissues, leaves, branches, stems, bulbs, tubers, roots, root hairs, rhizomes, cuttings, flowers, or fruits.

In some embodiments, the composition is a liquid and is applied as a spray to the aerial biomass of the plant and/or as a soil treatment.

In some embodiments, the composition is a liquid, and wherein the method comprises applying 1-10 L of the composition per hectare of the agricultural crop.

In some embodiments, the composition is a granule, and wherein the method comprises applying 5-15 kg of the composition per hectare of the agricultural crop.

In some embodiments, the composition is a granule, and wherein the method comprises applying an amount of the composition sufficient to deliver 10,000 to 2,000,000 spores of mycorrhizae per hectare of the agricultural crop.

In some embodiments, the method comprises applying the composition more than once.

In some embodiments, the method comprises applying the composition at the time of planting.

In some embodiments, the method comprises applying the composition pre-blooming and/or within thirty days of planting, sowing, or tillering.

### BRIEF DESCRIPTION OF THE SEVERAL VIEWS OF THE DRAWINGS

FIG. 1A shows a nutrient analysis of an illustrative digested microalgae solution (“DMS”) of the disclosure. FIG. 1B shows a nutrient analysis of an illustrative liquid composition of the present disclosure comprising 79% DMS and 21% cell free supernatant (“CFS”) of a microbial culture. FIG. 1C shows a nutrient analysis of an illustrative liquid composition of the present disclosure comprising 50% DMS and 50% CFS. FIG. 1D shows a nutrient analysis of an illustrative liquid composition of the present disclosure comprising 40% DMS and 60% CFS. FIG. 1E shows a nutrient analysis of an illustrative liquid composition of the present disclosure comprising 30% DMS and 70% CFS.

FIG. 2 shows a nutrient analysis of an illustrative CFS of the disclosure.

FIG. 3 shows an image of 3 DMS+CFS compositions, demonstrating non-precipitation and indicating pH of each one.

FIG. 4 shows a table disclosing exemplary component concentrations of illustrative compositions of the present disclosure comprising both mycorrhizae and CFS on a bentonite granule carrier.

FIG. 5 shows a table disclosing exemplary component concentrations of illustrative compositions of the present disclosure comprising mycorrhizae, DMS, and CFS on a bentonite granule carrier.

FIG. 6 shows exemplary yield increase for soybean crops following application of an illustrative DMS and CFS combination composition disclosed herein.

FIG. 7 shows exemplary yield increase for corn crops following application of an illustrative DMS and CFS combination composition disclosed herein.

FIG. 8A shows exemplary yield and revenue increase for coffee crops following application of an illustrative DMS and CFS combination composition disclosed herein. FIG. 8B shows images of coffee beans harvested from control and treated conditions, demonstrating a significant decrease in percentage of green beans in the treated condition.

FIG. 9A shows the average aerial biomass for each treatment condition at the first sampling in tomato plants. FIG. 9B shows individual detail of a tomato plant in each treatment during the first sampling. FIG. 9C shows general detail of tomato plants from each treatment during the first sampling.

FIG. 10A shows the average root biomass for each treatment condition at the first sampling in tomato plants. FIG. 10B shows a picture of tomato plant roots from each treatment condition at the first sampling.

FIG. 11 shows the average number of flowers per plant at the first sampling in tomato plants.

FIG. 12A shows the average aerial biomass for each treatment condition at the second sampling in tomato plants. FIG. 12B shows individual detail of a tomato plant in each treatment during the second sampling. FIG. 12C shows general detail of tomato plants from each treatment during the second sampling.

FIG. 13A shows the average root biomass for each treatment condition at the second sampling in tomato plants. FIG. 13B shows a picture of tomato plant roots from each treatment condition at the second sampling.

FIG. 14 shows the average number of flowers per plant at the second sampling in tomato plants.

FIG. 15 shows the antioxidant response (FRAP) in tomato plants in each treatment condition.

FIG. 16A shows the average aerial biomass for each treatment condition at the first sampling in lettuce. FIG. 16B shows individual detail of a lettuce plant in each treatment during the first sampling. FIG. 16C shows general detail of lettuce plants from each treatment during the first sampling.

FIG. 17 shows the average root biomass for each treatment condition at the first sampling in lettuce.

FIG. 18A shows the average aerial biomass for each treatment condition at the second sampling in lettuce. FIG. 18B shows general detail of lettuce plants from each treatment during the second sampling.

FIG. 19A shows the average root biomass for each treatment condition at the second sampling in lettuce. FIG. 19B shows a picture of lettuce plant roots from each treatment condition at the second sampling.

FIG. 20 shows the chlorophyl a content of lettuce plants in each treatment condition.

FIG. 21 shows the antioxidant response (FRAP) in lettuce plants in each treatment condition.

FIG. 22A-22F show the results of application of illustrative combination compositions of the disclosure to rice crops. FIG. 22A shows yield; FIG. 22B shows number of tillers; FIG. 22C shows panicle length; FIG. 22D shows an example side by side image of rice panicles, showing the difference in length; FIG. 22E shows test weight; and FIG. 22F shows a photo demonstrating the difference visually between treated and control crops.

FIG. 23A and FIG. 23B show the results of application of DMS/CFS/Myco and DMS/Myco granules to chili peppers. FIG. 23A shows the results for yield; FIG. 23B shows an image of example fruits from different conditions.

FIG. 24 shows the results of application of illustrative compositions of the disclosure to tomatoes, and their results on marketable yield and discarded fruit yield.

FIG. 25A-25C show the results for application of illustrative compositions of the disclosure to rice. FIG. 25A shows yield; FIG. 25B shows number of chaffy grains; and FIG. 25C shows an image of fully developed versus chaffy grains.

### DETAILED DESCRIPTION

### Definitions

The term “a” or “an” refers to one or more of that entity, i.e. can refer to plural referents. As such, the terms “a,” “an,” “one or more,” and “at least one” are used interchangeably herein. In addition, reference to “an element” by the indefinite article “a” or “an” does not exclude the possibility that more than one of the elements is present, unless the context clearly requires that there is one and only one of the elements.

Throughout this application, the term “about” is used to indicate that a value includes the inherent variation of error for the device or the method being employed to determine the value, or the variation that exists among the samples being measured. Unless otherwise stated or otherwise evident from the context, the term “about” means within 15% above or below the reported numerical value (except where such number would exceed 100% of a possible value or go below 0%). When used in conjunction with a range or series of values, the term “about” applies to the endpoints of the range or each of the values enumerated in the series, unless otherwise indicated. As used in this application, the terms “about” and “approximately” are used as equivalents.

As used herein, “microalgae” are eukaryotic microbial organisms that contain a chloroplast or other plastid, and optionally, are capable of performing photosynthesis and prokaryotic microbial organisms capable of performing photosynthesis. Microalgae include obligate photoautotrophs, which are organisms that use light energy (e.g. from sunlight or other light source) to convert inorganic materials into organic materials for use in cellular functions such as biosynthesis and respiration. Microalgae also include heterotrophs, which can live solely off of a fixed carbon source. Microalgae include unicellular organisms that separate from sister cells shortly after cell division, as well as microbes such as, for example, Volvox, which is a simple multicellular photosynthetic microbe of two distinct cell types. Microalgae also include other microbial photosynthetic organisms that exhibit cell-cell adhesion, such as Agmenellum, Anabaena, and Pyrobotrys. In some embodiments, the microalgae of the present disclosure are selected from the phyla Chlorophyta, Cryptophyta, Cyanophyta, Euglenophyta, Heterokontophyta, and Rhodophyta. In some embodiments, the microalgae of the present disclosure are selected from the genera Chlorella, Scenedesmus, Nannochloropsis, Muriellopsis, Isochrysis, Tisochrysis, Desmodesmus, Haematococcus, Arthrospira, and Anabaena. As used in this description, the term microalgae encompasses any form of microalgae, whether in a natural and unprocessed whole state, dried, extracted, or otherwise processed. In some embodiments, the term “microalgae” is used to refer to a lysed, hydrolyzed, digested, pulverized, or otherwise processed form of microalgae. In some embodiments, microalgae used in the compositions herein has the nutrient analysis depicted in FIG. TA. In some embodiments, microalgae is not macroalgae. In some embodiments, microalgae as used in the present compositions is not live microalgae.

As used herein, a “composition comprising microalgae” or “microalgae composition” refers to a composition comprising microalgae-derived components. Compositions comprising microalgae according to the present disclosure comprise, e.g., dried whole cell microalgae and/or lysed and digested microalgae. “Whole cell microalgae powder” refers to microalgae that has been dried and ground after being harvested. “Digested microalgae solution” or “DMS” refers to microalgae that has been dried, ground, and then processed to degrade cell walls and release peptides and other nutrients. DMS can be formulated using chemical, physical, or biological means to degrade cell walls and release peptides. As used herein, “microalgae dry matter” or “dry matter of microalgae” refers to the non-liquid content of a composition comprising microalgae.

As used herein, the terms “mycorrhiza” and “mycorrhizae” refer to mycorrhizal fungi. A mycorrhiza is a mutual symbiotic association between a fungus and a plant and the term is also used herein to refer to the fungus itself “Ectomycorrhizae” is used to refer to mycorrhizal fungi that colonize host plant root tissues extracellularly. “Endomycorrhizae” is used to refer to mycorrhizal fungi that colonize host plant tissues intracellularly. In some embodiments, the compositions of the present disclosure comprise both ectomycorrhizae and endomycorrhizae.

In some embodiments, the compositions of the present disclosure comprise predominantly endomycorrhizae, e.g., more than 90% endomycorrhizae.

As used herein, a “granule” refers to a dry, granular composition having an average diameter of less than about 1 cm for administration to agricultural crops.

As used herein, a “seed coating” refers to a composition applied to the seeds of an agricultural crop before or during planting.

As used herein, an “agricultural crop” refers to any plant that is harvested for commercial purposes. Agricultural crops include agronomic crops, horticultural crops, and ornamental plants. “Agronomic crops” are those that occupy large acreage and are the bases of the world's food and fiber production systems, often mechanized. Examples are wheat, rice, corn, soybean, alfalfa and forage crops, beans, sugar beets, canola, and cotton. “Horticultural crops” are used to diversify human diets and enhance the living environment. Vegetables, fruits, flowers, ornamentals, and lawn grasses are examples of horticultural crops and are typically produced on a smaller scale with more intensive management than agronomic crops. “Ornamental plants” are grown for decoration and include flowers, shrubs, grasses, and trees. Agricultural crops include both monocots and dicots. Monocots include most of the bulbing plants and grains, including agapanthus, asparagus, bamboo, bananas, corn, daffodils, garlic, ginger, grass, lilies, onions, orchids, rice, sugarcane, tulips, and wheat. Dicots include many garden flowers and vegetables, including legumes, the cabbage family, and the aster family. Examples of dicots are apples, beans, broccoli, carrots, cauliflower, cosmos, daisies, peaches, peppers, potatoes, roses, sweet pea, and tomatoes. Agricultural crops also include food crops, feed crops, cereal crops, oil seed crop, pulses, fiber crops, sugar crops, forage crops, medicinal crops, root crops, tuber crops, vegetable crops, fruit crops, and garden crops. The terms “host plant” and “agricultural crop” are used interchangeably herein.

As used herein, the term “carrier” is intended to include an “agronomically acceptable carrier.” An “agronomically acceptable carrier” is intended to refer to any material which can be used to deliver a composition as described herein, alone or in combination with one or more agriculturally beneficial ingredient(s), and/or biologically active ingredient(s), to a plant, a plant part (e.g., a leaf or a seed), or a soil. In some embodiments, the carrier can be added to the plant, plant part or soil without having an adverse effect on plant growth or soil fitness.

As used herein, “cell-free supernatant” or “CFS” refers to the cell-free supernatant of a microbial culture comprising one or more species of microorganisms. In some embodiments, the genera of the one or more microorganisms are selected from the list consisting of Aspergillus spp., Bacillus spp., Rhodopseudomonas spp., Candida spp., Lactobacillus spp., Lactococcus spp., Pseudomonas spp., Saccharomyces spp., or Streptococcus spp.

Compositions Comprising Cell-Free Supernatant, Microalgae and/or Mycorrhizae

The present disclosure relates to compositions comprising a cell-free supernatant (“CFS”) of a microbial culture along with microalgae and/or mycorrhizae for improving one or more parameters of a host plant. In some embodiments, the compositions comprise a cell-free supernatant obtained from the culture of a microbial consortia. In some embodiments, the compositions comprise dried whole cell or digested microalgae. In some embodiments, the compositions comprise mycorrhizae, e.g., predominantly endomycorrhizae. In some embodiments, the compositions are granules comprising microalgae and mycorrhizae. In some embodiments, the granules comprise a clay or mineral based carrier. In some embodiments, the compositions are liquid formulations comprising CFS and microalgae. The present compositions are based, in part, on the surprising synergy among microbial supernatants, microalgae-derived components, and mycorrhizae for improving one or more plant parameters.

### Cell-Free Supernatant

In one aspect, the present disclosure provides compositions comprising a cell-free supernatant (“CFS”) of a microbial culture. In some embodiments, the microbial culture comprises a mixture of microorganisms, which may comprise one or more of bacteria, fungi, algae, and/or microorganisms.

In some embodiments, the compositions comprise the CFS of a microbial culture inoculated with an isolated microorganism, wherein the microorganism comprises one or more of Aspergillus spp., Bacillus spp., Rhodopseudomonas spp., Candida spp., Lactobacillus spp., Lactococcus spp., Pseudomonas spp., Saccharomyces spp., or Streptococcus spp.; or combinations thereof.

In some embodiments, a composition of the disclosure comprises the CFS of a microbial culture inoculated with a mixed culture, IN-M1, ATCC Patent Deposit Designation No. PTA-12383. In some embodiments, the composition comprises the CFS of a microbial culture inoculated with a mixed culture, IN-M2, deposited with the ATCC Patent Depository under the Budapest Treaty, on Sep. 4, 2014, with the designation IN-M2, under Account No. 200139, with the ATCC Patent Deposit Designation No. PTA-121556. In some embodiments, the CFS is filter-sterilized.

In some embodiments, the CFS is from a microbial culture comprising Aspergillus spp., wherein the species is Aspergillus oryzae, or wherein the Aspergillus spp. is Aspergillus oryzae, IN-AO1, deposited with the ATCC Patent Depository under the Budapest Treaty, on Sep. 4, 2014, with the designation IN-AO1, under Account No. 200139, with the ATCC Patent Deposit Designation No. PTA-121551. In some embodiments, the microbial culture comprises Bacillus subtilis or Bacillus subtilis, IN-BS1, ATCC Patent Deposit Designation No. PTA-12385. In some embodiments, the culture comprises Rhodopseudomonas palustris, or Rhodopseudomonas palustris, IN-RP1, Accession No, PTA-12387. In some embodiments, the culture comprises Candida utilis or Candida utilis, IN-CU1, deposited with the ATCC Patent Depository under the Budapest Treaty, on Sep. 4, 2014, with the designation IN-CU1, under Account No. 200139, with the ATCC Patent Deposit Designation No. PTA-121550. In some embodiments, the culture comprises Lactobacillus casei, Lactobacillus helveticus, Lactobacillus lactis, Lactobacillus rhamnosus, or Lactobacillus plantarum, or combinations thereof. In some embodiments, the culture comprises Lactobacillus helveticus, IN-LH1, ATCC Patent Deposit Designation No. PTA-12386. In some embodiments, the culture comprises Lactobacillus casei, referred to herein as IN-LC1, which was deposited with the ATCC Patent Depository under the Budapest Treaty, with the designation IN-LC1, on Sep. 4, 2014, under Account No. 200139, with the ATCC Patent Deposit Designation No. PTA-121549. In some embodiments, the culture comprises Lactobacillus lactis, IN-LL1, which was deposited with the ATCC Patent Depository under the Budapest Treaty, with the designation IN-LL1, on Sep. 4, 2014, under Account No. 200139, with the ATCC Patent Deposit Designation No. PTA-121552. In some embodiments, the culture comprises Lactobacillus plantarum, IN-LP1, deposited with the ATCC Patent Depository under the Budapest Treaty, on Sep. 4, 2014, with the designation IN-LP1, under Account No. 200139, with the ATCC Patent Deposit Designation No. PTA-121555. In some embodiments, the culture comprises Lactobacillus rhamnosus, IN-LR1, deposited with the ATCC Patent Depository under the Budapest Treaty, on Sep. 4, 2014, with the designation IN-LR1, under Account No. 200139, with the ATCC Patent Deposit Designation No. PTA-121554. In some embodiments, the culture comprises Pseudomonas aeruginosa. In some embodiments, the culture comprises Rhodopseudomonas palustris. In some embodiments, the culture comprises Rhodopseudomonas palustris, IN-RP1, ATCC Patent Deposit Designation No. PTA-12383. In some embodiments, the culture comprises Rhodopseudomonas palustris, IN-RP2, deposited with the ATCC Patent Depository under the Budapest Treaty, on Sep. 4, 2014, with the designation IN-RP2, under Account No. 200139, with the ATCC Patent Deposit Designation No. PTA-121553. In some embodiments, the culture comprises Saccharomyces cerevisiae. In some embodiments, the culture comprises Saccharomyces cerevisiae, IN-SC1, ATCC Patent Deposit Designation No. PTA- 12384. In some embodiments, the culture comprises Streptococcus lactis. In some embodiments, the culture comprises at least two of Aspergillus spp., Bacillus spp., Rhodopseudomonas spp., Candida spp., Lactobacillus spp., Pseudomonas spp., Saccharomyces spp., or Streptococcus spp. In some embodiments, the culture comprises Aspergillus oryzae, Bacillus subtilis, Lactobacillus helveticus, Lactobacillus casei, Rhodopseudomonas palustris, and Saccharomyces cervisisae.

CFS compositions of the present disclosure are CFSs of microbial cultures inoculated with one or more isolated microorganisms. Examples of these microorganisms include, but are not limited to, Aspergillus spp., Bacillus spp., Rhodopseudomonas spp., Candida spp., Lactobacillus spp., Lactococcus spp., Pseudomonas spp., Saccharomyces spp., and Streptococcus spp. Microbial cultures disclosed herein may comprise differing amounts and combinations of these and other microorganisms depending on the methods being performed by particular cell-free supernatant compositions.

In various aspects, the microorganisms cultured to produce the cell-free supernatant compositions of the present disclosure can be grown in large, industrial scale quantities. For example, and not to be limiting, a method for growing microorganisms in 1000 liter batches comprises media comprising 50 liters of non-sulphur agricultural molasses, 3.75 liters wheat bran, 3.75 liters kelp, 3.75 liters bentonite clay, 1.25 liters fish emulsion, 1.25 liters soy flour, 675 mg commercially available sea salt, 50 liters of selected strains of microorganisms, up to 1000 liters non-chlorinated warm water to form a microbial culture. A method for growing the microorganisms can further comprise dissolving molasses in some of the warm water, adding the other ingredients listed above to the fill tank, keeping the temperature at 30° C., and, after the pH drops to about 3.7 within 5 days, stirring lightly once per day and monitoring pH, forming a microbial culture. The microbial culture can incubate for 2-8 weeks. After the time period determined for incubation, the microorganisms are separated from the liquid portion of the microbial culture, and the cell-free liquid remaining is a cell-free supernatant composition of the present disclosure. A cell-free supernatant composition may be bottled and stored, for example, in airtight containers, or out of sunlight, for example, at room temperature. Microbial cultures can be made as taught in U.S. patent application Ser. No. 13/979,419, which is herein incorporated by reference in its entirety.

In an aspect, a microbial culture comprises an Aspergillus spp. such as Aspergillus oryzae. In an aspect, the Aspergillus spp. is Aspergillus oryzae, referred to herein as IN-AO1, which was deposited with the ATCC Patent Depository under the Budapest Treaty, with the designation IN-AO1, on Sep. 4, 2014, under Account No. 200139, with the ATCC Patent Deposit Designation No. PTA-121551.

In an aspect, a microbial culture comprises a Bacillus spp. such as Bacillus subtilis. In an aspect, the Bacillus spp. is Bacillus subtilis, referred to herein as IN-BS1, which was deposited with the ATCC under the Budapest Treaty, on Jan. 12, 2011, under Account No. 200139, and given ATCC Patent Deposit Designation No. PTA12385.

In an aspect, a microbial culture comprises a Rhodopseudomonas spp. such as Rhodopseudomonas palustris. In an aspect, the Rhodopseudomonas spp. is Rhodopseudomonas palustris, referred to herein as IN-RP1, which was deposited with the ATCC under the Budapest Treaty, on Jan. 12, 2011, under Account No. 200139, and given ATCC Patent Deposit Designation No. PTA-12387.

In an aspect, a microbial culture comprises a Candida spp. such as Candida utilis. In an aspect, the Candida spp. is Candida utilis, referred to herein as IN-CU1, which was deposited with the ATCC Patent Depository under the Budapest Treaty, with the designation IN-CU1, on Sep. 4, 2014, under Account No. 200139, with the ATCC Patent Deposit Designation No. PTA-121550.

In an aspect, a microbial culture comprises a Lactobacillus spp. such as Lactobacillus helveticus, Lactobacillus casei, Lactobaccillus rhamnosus, or Lactobacillus plantarum, or combinations thereof. In an aspect, the Lactobacillus spp. is Lactobacillus helveticus. In an aspect, the Lactobacillus spp. is Lactobacillus helveticus, referred to herein as IN-LH1, which was deposited with the ATCC under the Budapest Treaty, on Jan. 12, 2011, under Account No. 200139, and given ATCC Patent Deposit Designation No. PTA-12386. In an aspect, a microbial culture comprises a Lactobacillus spp. such as Lactobacillus plantarum. In an aspect, the Lactobacillus spp. is Lactobacillus plantarum, referred to herein as IN-LP1, which was deposited with the ATCC Patent Depository under the Budapest Treaty, on Sep. 4, 2014, with the designation IN-LP1, under Account No. 200139, with the ATCC Patent Deposit Designation No. PTA-121555. In an aspect, a microbial culture comprises an Lactobacillus spp. such as Lactobacillus rhamnosus. In an aspect, the Lactobacillus spp. is Lactobacillus rhamnosus, referred to herein as IN-LR1, which was deposited with the ATCC Patent Depository under the Budapest Treaty, with the designation IN-LR1, on Sep. 4, 2014, under Account No. 200139, with the ATCC Patent Deposit Designation No. PTA-121554. In an aspect, a microbial culture comprises an Lactobacillus spp. such as Lactobacillus lactis. In an aspect, the Lactobacillus spp. is Lactobacillus lactis, referred to herein as IN-LL1, which was deposited with the ATCC Patent Depository under the Budapest Treaty, with the designation IN-LL1, on Sep. 4, 2014, under Account No. 200139, with the ATCC Patent Deposit Designation No. PTA-121552. In an aspect, a microbial culture comprises a Lactobacillus spp. such as Lactobacillus casei. In an aspect, the Lactobacillus spp. is Lactobacillus casei, referred to herein as IN-LC1, which was deposited with the ATCC Patent Depository under the Budapest Treaty, with the designation IN-LC1, on Sep. 4, 2014, under Account No. 200139, with the ATCC Patent Deposit Designation No. PTA-121549.

In an aspect, a microbial culture comprises a Pseudomonas spp. such as Pseudomonas aeruginosa. In an aspect, the Pseudomonas spp. is Pseudomonas aeruginosa.

In an aspect, a microbial culture comprises a Rhodopseudomonas spp. such as Rhodopseudomonas palustris. In an aspect, the Rhodopseudomonas spp. is Rhodopseudomonas palustris, referred to herein as IN-RP1, which was deposited with the ATCC under the Budapest Treaty, on Jan. 12, 2011, under Account No. 200139, and given ATCC Patent Deposit Designation No. PTA-12383. In an aspect, a microbial culture comprises a Rhodopseudomonas spp. such as Rhodopseudomonas palustris, referred to herein as IN-RP2, which was deposited with the ATCC Patent Depository under the Budapest Treaty, on Sep. 4, 2014, with the designation IN-RP2, under Account No. 200139, with the ATCC Patent Deposit Designation No. PTA-121553.

In an aspect, a microbial culture comprises a Saccharomyces spp. such as Saccharomyces cerevisiae. In an aspect, the Saccharomyces spp. is Saccharomyces cerevisiae, referred to herein as IN-SC1, which was deposited with the ATCC under the Budapest Treaty, on Jan. 12, 2011, under Account No. 200139, and given ATCC Patent Deposit Designation No. PTA-12384. In an aspect, a microbial culture comprises a Saccharomyces spp. such as Saccharomyces lactis.

A microbial culture may comprise a mixture of isolated microorganisms comprising Aspergillus oryzae, referred to herein as IN-AO1 (ATCC Patent Deposit Designation No. PTA-121551), Bacillus subtilis, referred to herein as IN-BS1 (ATCC Patent Deposit Designation No. PTA-12385), Rhodopseudomonas palustris, referred to herein as IN-RP1 (ATCC Patent Deposit Designation No. PTA-12387), Candida utilis, referred to herein as IN-CU1 (ATCC Patent Deposit Designation No. PTA-121550), Lactobacillus casei, referred to herein as IN-LC1 (ATCC Patent Deposit Designation No. PTA-121549), Lactobacillus helveticus, referred to herein as IN-LH1 (ATCC Patent Deposit Designation No. PTA-12386), Lactobaccillus rhamnosus, referred to herein as IN-LR1 (ATCC Patent Deposit Designation No. PTA-121554), Lactobacillus plantarum, referred to herein as IN-LP1 (ATCC Patent Deposit Designation No. PTA-121555), Pseudomonas aeruginosa, Rhodopseudomonas palustris, referred to herein as IN-RP1 (ATCC Patent Deposit Designation No. PTA-12387), Rhodopseudomonas palustris, referred to herein as IN-RP2 (ATCC Patent Deposit Designation No. PTA-121553), Saccharomyces cerevisiae, referred to herein as IN-SC1 (ATCC Patent Deposit Designation No. PTA-12384), and Saccharomyces lactis. Examples of isolated microorganisms inoculated in microbial cultures of the present disclosure include, but are not limited to, Aspergillus oryzae, Rhodopseudomonas palustris, Candida utilis, Lactobacillus helveticus, Lactobacillus casei, Lactobaccillus rhamnosus, Lactobacillus plantarum, Pseudomonas aeruginosa, Rhodopseudomonas palustris, Saccharomyces cerevisiae, and Saccharomyces lactis.

Microbial cultures may comprise differing amounts and combinations of these and other isolated microorganisms. Thus, in various aspects, a microbial culture is inoculated with of at least two of the following: Aspergillus spp., Bacillus spp., Rhodopseudomonas spp., Candida spp., Lactobacillus spp., Pseudomonas spp., Saccharomyces spp., or Streptococcus spp. In an aspect, a microbial culture is inoculated with Aspergillus oryzae, Bacillus subtilis, Lactobacillus helveticus, Lactobacillus casei, Rhodopseudomonas palustris, and Saccharomyces cerevisiae. In an aspect, a microbial culture is inoculated with a mixed culture, IN-M1 (ATCC Patent Deposit Designation No. PTA-12383). The deposited mixed culture, IN-M1, consists of the strains IN-LH1, IN-BS1, IN-SC1, IN-RP1; and Lactobacillus casei and Aspergillus oryzae, using the designations used hereinbefore. In an aspect, a microbial culture is inoculated with Aspergillus oryzae, Bacillus subtilis, Candida utilis, Lactobacillus casei, Lactobacillus helveticus, Lactobacillus plantarum, Lactobacillus rhamnosus, Lactococcus lactis, Rhodopseudomonas palustris, and Saccharomyces cerevisiae. In an aspect, a microbial culture is inoculated with and comprises a mixed culture, referred to herein as IN-M2, which was deposited with the ATCC Patent Depository under the Budapest Treaty, on Sep. 4, 2014, with the designation IN-M2, under Account No. 200139, with the ATCC Patent Deposit Designation No. PTA-121556. The deposited mixed culture, IN-M2, consists of the strains IN-LC1, IN-LH1, IN-LP1, IN-LR1, IN-LL1, IN-BST, IN-AO1, IN-SC1, IN-CU1, IN-RP1, and IN-RP2, using the designations used hereinbefore. Any of the disclosed microbial cultures can be the microbial culture source for a cell-free supernatant composition of the present disclosure. Cell-free supernatant compositions of the present disclosure are useful in the methods taught herein.

In an aspect, a cell-free supernatant is diluted in water. In an aspect, a cell-free supernatant is diluted in water from a stock concentration of cell-free supernatant to about 1/10, 1/20, 1/30, 1/40, 1/50, 1/60, 1/70, 1/80, 1/90, 1/100, 1/150, or 1/200 in water.

Also disclosed are methods for preparing a cell-free supernatant composition comprising the steps of: (a) inoculating a fermentation broth with one or more isolated microorganisms, wherein the microorganisms comprises Aspergillus spp., Bacillus spp., Rhodopseudomonas spp., Candida spp., Lactobacillus spp., Pseudomonas spp., Saccharomyces spp., or Streptococcus spp.; or combinations thereof; (b) incubating the inoculated fermentation broth for at least five hours; and (c) centrifuging the culture after step (b) for at least 10 minutes at a centrifugal force of 10,000×g; thereby providing the cell-free supernatant.

Microbial consortia such as IN-M1 deposited with ATCC Patent Deposit No. PTA-12383 or IN-M2 deposited with ATCC Deposit No. PTA-121556 can be cultured as described in U.S. Pat. Nos. 10,588,320 and 10,561,149, incorporated by reference herein in their entireties.

In some embodiments, the CFS has about 95-99% w/w water content. In some embodiments, the CFS has about 98% w/w water content. In some embodiments, the CFS has about 1-5% w/w dry matter. In some embodiments, the CFS has about 2% w/w dry matter. In some embodiments, the CFS has a density around that of water, e.g., around 1 g/mL. In some embodiments, the pH of the CFS is between 7 and 8. In some embodiments, the pH of the CFS is about 7.5. In some embodiments, the organic matter content is about 0.5-30.0% w/w. In some embodiments, the organic matter content is about 1.0-20.0% w/w. In some embodiments, the organic carbon content is about 0.1-2.0% w/w. In some embodiments, the organic carbon content is about 1% w/w. In some embodiments, the total nitrogen content is about 0.05-0.5% w/w. In some embodiments, the total nitrogen content is about 0.25% w/w. In some embodiments, the CFS does not have a significant concentration of amino acids.

### Microalgae

Within the present compositions, microalgae are eukaryotic microbial organisms that contain a chloroplast or other plastid, and optionally, are capable of performing photosynthesis, and prokaryotic microbial organisms capable of performing photosynthesis. Microalgae may exist individually, or in chains or groups and can range in size from a few micrometers to a few hundred micrometers. Microalgae do not have roots, stems, or leaves. Microalgae capable of performing photosynthesis are important for life on earth; they produce approximately half of the atmospheric oxygen and use simultaneously the greenhouse gas carbon dioxide to grow photoautotrophically. Microalgae, together with bacteria, form the base of the food web and provide energy for all the trophic levels above them. Microalgae biomass is often measured with chlorophyll a concentrations and can provide a useful index of potential production. Microalgae include obligate photoautotrophs, which cannot metabolize a fixed carbon source as energy, as well as heterotrophs, which can live solely off of a fixed carbon source.

The compositions of the present disclosure comprise microalgae. In some embodiments, the compositions comprise microalgae of a phylum selected from the list consisting of: Cyanobacteria, Chlorophyta, Rhodophyta, Bacillariophyta, Cryptophyta, Dinophyta, Euglenozoa, Haptophyta, Ochrophyta, Cyanophyta, Euglenophyta, Heterokontophyta, and Rhodophyta. In some embodiments, the microalgae included in compositions of the present disclosure are selected from the phyla Chlorophyta, Cryptophyta, Cyanophyta, Euglenophyta, Heterokontophyta, and Rhodophyta.

In some embodiments, the microalgae are of a genus selected from the list consisting of: Anabaena, Aphanizomenon, Arthrospira, Auxenochlorella, Botryococcus, Carteria, Chaetoceros, Chlamydomonas, Chlorella, Chlorococcum, Chroomonas, Coccomyxa, Crypthecodinium, Cryptomonas, Cyclotella, Desmodesmus, Dicrateria, Dunaliella, Euglena, Haematococcus, Isochrysis, Microcystis, Micromonas, Monochrysis, Muriellopsis, Nannochloropsis, Navicula, Neochloris, Nitzschia, Nostoc, Olisthodiscus, Phaeodactylum, Pseudoisochrysis, Pyramimonas, Rhodomonas, Scenedesmus, Schizochytrium, Skeletonema, Spirulina, Synechococcus, Tetraselmis, Thalassiosira, Tisochrysis, and Tolypothrix. In some embodiments, the microalgae of the present disclosure are selected from the genera Chlorella, Scenedesmus, Nannochloropsis, Muriellopsis, Isochrysis, Tisochrysis, Desmodesmus, Haematococcus, Arthrospira, and Anabaena. In some embodiments, the compositions of the present disclosure comprise microalgae of a single genus or species. In some embodiments, the compositions of the present disclosure comprise microalgae of a consortia of microalgae genera or species.

Methods for culturing microalgae are known in the art. In some embodiments, the microalgae are grown according to conventional means for culturing microalgae. In some embodiments, initial microalgae strains and inoculum are generated and maintained in small volumes. Microalgae strains and cells intended for inclusion in the compositions can be selected based on the desired nutrient profile. In some embodiments, microalgae are grown through intensive and controlled culture of microalgae using photobioreactors. Photobioreactors allow the passage of light so that photosynthesis can occur while microalgae grow in optimized culture media. Any form of photobioreactor can be used to grow the microalgae of the present disclosure, include flat panel and tubular photobioreactors. Raceways may also be used for culturing microalgae. During microalgae growth, parameters such as pH, temperature, nutrients, dissolved oxygen and carbon dioxide injection can be maintained in order to ensure maximum production rates.

In some embodiments, microalgae are grown until biomass reaches 0.5-5.0 g/L. Microalgae are then harvested. In some embodiments, microalgae biomass is separated from the liquid culture, e.g., by centrifugation, settling, and/or filtration. Following separation of the biomass, the microalgae biomass is processed, in some embodiments, to ensure that microalgae are not living and/or to make available nutrients from within the microalgal cells. For example, in some embodiments, the biomass is dried. In some embodiments, the biomass is baked, dehydrated, dessicated, freeze-dried, and/or exposed to evaporative drying. In some embodiments, the microalgae is ground after drying to achieve a smaller particle size. In some embodiments, the dried microalgae is ground to a size of 1-10,000 microns. In some embodiments, the dried microalgae is ground to a size of 100-1,000 microns. A dried, ground composition of microalgae cells is referred to herein as “whole cell microalgae powder.” In some embodiments, a composition herein comprises 0.1-50 g/L of whole cell microalgae powder. In some embodiments, a composition herein comprises 0.8-20 g/L of whole cell microalgae powder.

In some embodiments, after separation of the biomass of the microalgae cells from the liquid solution, the microalgae is further processed to degrade cell walls and release nutrients, producing a digested microalgae solution or “DMS” of the present disclosure. Microalgae cells can be degraded by physical, mechanical, chemical, enzymatic, or biological means. In some embodiments, microalgae cells are physically disrupted, e.g., using high pressure and/or mechanical lysis. In some embodiments, microalgae cells are chemically disrupted, e.g., using acids. In some embodiments, microalgae cells are biologically disrupted, e.g., using enzymatic processes including proteolysis.

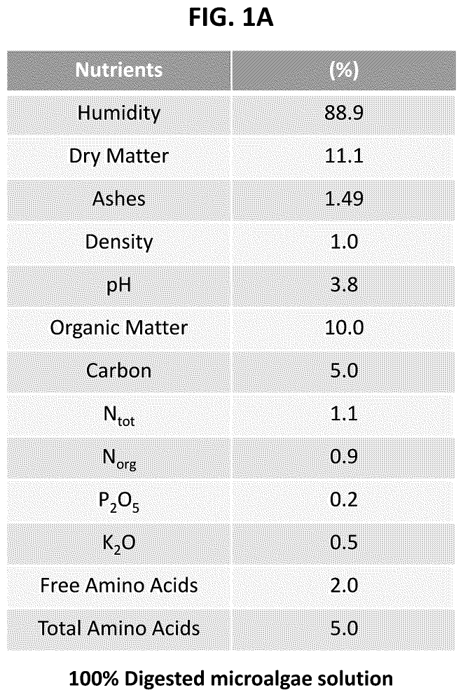

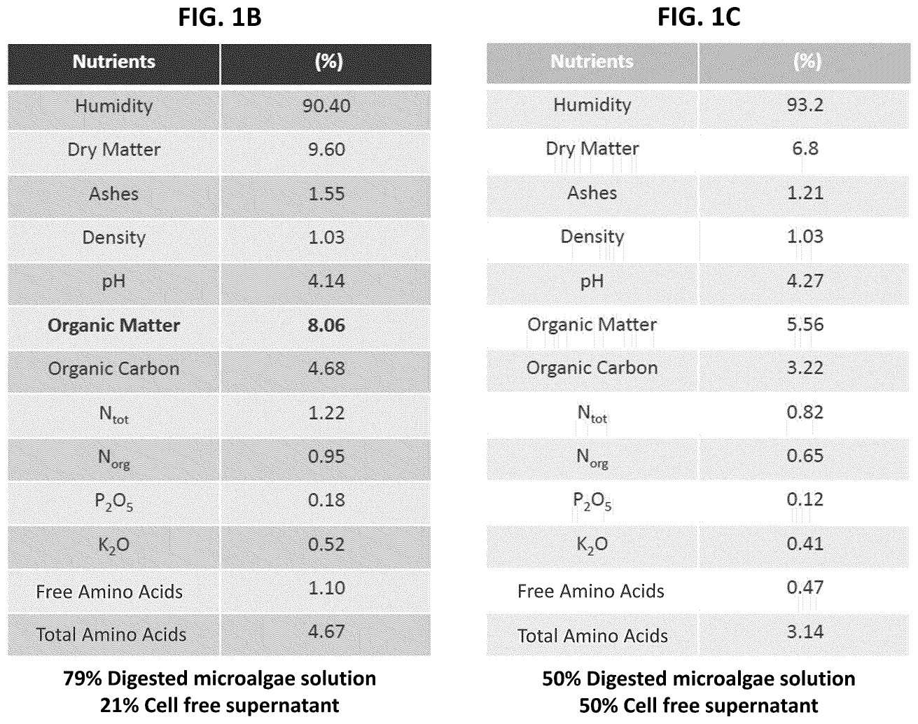

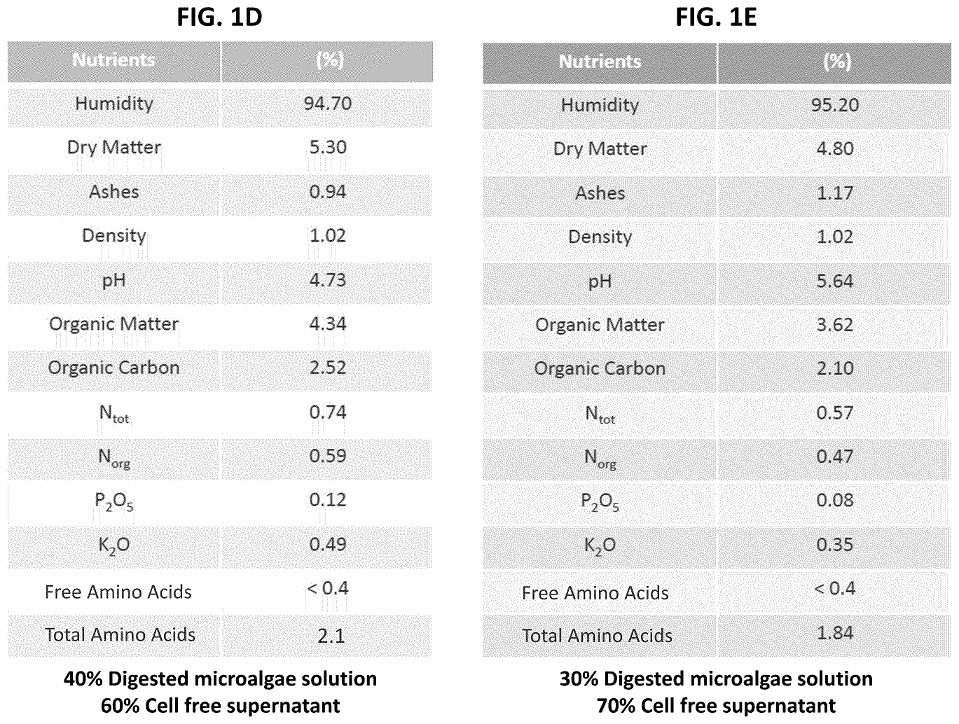

In some embodiments, the DMS has a nutrient profile as shown in FIG. 1A. In some embodiments, humidity, e.g., water content, of DMS is about 75-95% w/w. In some embodiments, humidity is about 90% w/w. In some embodiments, dry matter is about 5-25% w/w. In some embodiments, dry matter is about 10% w/w. In some embodiments, the content of organic matter is about 5-20% w/w. In some embodiments, the content of organic matter is about 10% w/w. In some embodiments, the carbon content is about 1-15% w/w. In some embodiments, the carbon content is about 5% w/w. In some embodiments, the total nitrogen content of DMS is about 0.1-3.0% w/w. In some embodiments, the total nitrogen content of DMS is about 1-1.5% w/w. In some embodiments, the phosphorous content of DMS is about 0.05-0.5% w/w. In some embodiments, the phosphorous content of DMS is about 0.1% w/w. In some embodiments, the P₂O₅ content of DMS is about 0.05-0.5% w/w. In some embodiments, the P₂O₅ content of DMS is about 0.2% w/w. In some embodiments, the potassium content of DMS is about 0.1-1.0% w/w. In some embodiments, the potassium content of DMS is about 0.4% w/w. In some embodiments, the K₂O content of DMS is about 0.1-1.0% w/w. In some embodiments, the K₂O content of DMS is about 0.5% w/w. In some embodiments, the total nitrogen, phosphorous, and potassium (“NPK”) content including the weight of P₂O₅ and K₂O is about 0.5-5.0% w/w. In some embodiments, the total NPK content including the weight of P₂O₅ and K₂O is about 1.8% w/w. In some embodiments, the total amino acid content of DMS is about 1-15% w/w. In some embodiments, the total amino acid content of DMS is about 5% w/w. In some embodiments, the free amino acid content of DMS is 0.1-10% w/w. In some embodiments, the free amino acid content of DMS is about 2% w/w. In some embodiments, the density of DMS is about 1-1.1 g/mL. In some embodiments, the density of DMS is similar to that of water, i.e., around 1 g/mL. In some embodiments, the pH of DMS is acidic or is adjusted to be acidic. In some embodiments, the pH of DMS is or is adjusted to be about pH 3.5-pH 4.5. In some embodiments, the pH of DMS is adjusted to be around pH 6.0-6.5 or to match the pH of a carrier composition.

In some embodiments, the whole cell microalgae powder comprises the same amounts and/or ratios of components as DMS but with significantly less water content. In some embodiments, the whole-cell microalgae powder comprises less than 10% humidity by weight. In some embodiments, the whole-cell microalgae powder comprises less than 5% humidity by weight. In some embodiments, the whole-cell microalgae powder comprises 1-3% w/w humidity.

In some embodiments, the microalgae components of the present compositions comprise proteins, peptides, amino acids, plant hormones, phytohormones, carbohydrates, fatty acids, vitamins, minerals, polysaccharides, carotenoids, pigments, fibers, and other natural nutrients.

In some embodiments, the compositions disclosed herein differ from macroalgae and other biostimulant products in that the disclosed microalgae-derived compositions comprise a richer and more balanced biochemical composition. In some embodiments, the microalgae components of the present compositions provide all the essential free amino acids. In some embodiments, the microalgae components provide micronutrients, macronutrients, polyunsaturated fatty acids, antioxidants, carotenoids, and vitamins, as well as a high content and wide range of phytohormones. In some embodiments, the microalgae components help maintain the organic carbon in the soil and improve nutrient uptake. In some embodiments, the microalgae components provide a complete nutritional package to growing plants and help fight against abiotic stresses, improving the quality of the produce and the marketable yield.

In some embodiments, a composition of the disclosure, e.g., a granule composition, comprises 0.1%-10.0% w/w DMS. In some embodiments, a composition of the disclosure comprises 0.5%-5.0% w/w DMS.

In some embodiments, a composition of the disclosure, e.g., a liquid composition, comprises 10-100% w/w DMS. In some embodiments, a liquid composition comprising DMS is diluted to 0.3%-0.5% v/v in water prior to application.

In some embodiments, in terms of dry matter of microalgae, a composition comprises 0.01%-20% dry matter of microalgae. In some embodiments, in terms of dry matter of microalgae, a composition comprises 0.5%-5% dry matter of microalgae. In some embodiments, in terms of dry matter of microalgae, a composition comprises 0.05%-0.5% dry matter of microalgae. In some embodiments, in terms of dry matter of microalgae, a composition comprises 0.03%-0.05% dry matter of microalgae.

In some embodiments, a composition of the disclosure, e.g., a seed coating, comprises 5-95% w/w whole-cell microalgae powder. In some embodiments, a composition of the disclosure comprises 10-90% w/w whole-cell microalgae powder. In some embodiments, a composition of the disclosure comprises 20-80% w/w whole-cell microalgae powder.

In some embodiments, a composition of the disclosure, e.g., a liquid formulation, comprises 0.1-40 g/L whole-cell microalgae powder. In some embodiments, a composition of the disclosure, e.g., a liquid formulation, comprises 0.8-20 g/L whole-cell microalgae powder.

### Mycorrhizae

A mycorrhiza is a symbiotic association between a fungus and the roots of a vascular plant. As used herein, the terms mycorrhiza and mycorrhizae are also used to refer to the mycorrhizal fungi. This type of association is found in 85% of all plant families in the wild, including many crop species such as grains. In the association between mycorrhizae and plant roots, the fungus colonizes the host plant's roots, either intracellularly or extracellularly. The functional symbiosis provides a suitable and sufficient carbohydrate source for the fungal symbiont. The plant symbiont benefits can be numerous and include improved nutrient and water uptake, additional carbon acquisition, increased sink strength for photosynthate translocation, increased production of phytohormones, improved resistance to pathogens, and heavy metal tolerance. Mycorrhizae are critically important organs for resource uptake by most terrestrial plants. In the absence of an appropriate fungal symbiont, many terrestrial plants suffer from resource limitations and ultimately reduced growth, and poor fitness. Mycorrhizae protect plants from adverse conditions, such as lack of water and nutrients.

Mycorrhizal fungi are commonly divided into “ectomycorrhiza” (the hypha of fungi do not penetrate individual cells with in the root) and “endomycorrhiza” (the hypha of fungi penetrate the cell wall and invaginate the cell membrane). In the case of endomycorrhizae, fungal hyphae grow into the intercellular wall spaces of the cortex and penetrate individual cortical cells. As they extend into the cell, they do not break the plasma membrane or the tonoplast of the host cell. Instead, the hypha is surrounded by these membranes and forms structures known as arbuscules, which participate in nutrient ion exchange between the host plant and the fungus. (Mauseth,1988). Calculations show that a root associated with mycorrhizal fungi can transport phosphate at a rate more than four times higher than that of a root not associated with mycorrhizae (Nye and Tinker, 1977).

Endomycorrhizae are variable and are further classified as arbuscular, ericoid, arbutoid, monotropoid and orchid mycorhizae. Arbuscular mycorrhizal fungi (“AMF”) are ubiquitous in soil habitats and form beneficial symbiosis with the roots of angiosperms and other plants. AMF are typically associated with the roots of herbaceous plants, but may also be associated with woody plants. AMF are an example of a mycorrhiza that involves entry of the hyphae into the plant root cell walls to produce structures that are either balloon-like (vesicles) or dichotomously-branching invaginations (arbuscules). The fungal hyphae do not in fact penetrate the protoplast (i.e., the interior of the cell), but invaginate the cell membrane. The structure of the arbuscules greatly increases the contact surface area between the hypha and the cell cytoplasm to facilitate the transfer of nutrients between them.

Of the symbiotic associations of plant and fungi, those involving an association between plants and Glomeromycota fungi has the widest distribution in the nature. Arbuscular mycorrhiza fungi inhabit a variety of ecosystems including agricultural lands, forests, grasslands and many stressed environments, and these fungi colonize the roots of most plants, including bryophytes, pteridophytes, gymnosperms and angiosperms. Arbuscular mycorrhizal fungi belong to the family Endogonaceae, of the order Muccorales, of the class Zygomycetes. The arbuscular mycorrhizal forming genera of the family includes Acaulospora, Entrophospora, Gigaspora, Glomus, Sclerocystis and Scutellospora.

In some embodiments, the compositions of the present disclosure comprise both ectomycorrhizae and endomycorrhizae. In some embodiments, the compositions of the present disclosure comprise predominantly endomycorrhizae. In some embodiments, the compositions of the present disclosure comprise more than 50%, 60%, 70%, 80%, or 90% endomycorrhizae as a percentage of overall mycorrhizae content. In some embodiments, the compositions of the present disclosure comprise more than 95% endomycorrhizae as a percentage of overall mycorrhizae content. In some embodiments, only endomycorrhiza are used in the coating mixture, while in some embodiments, a combination of ectomycorrhiza and endomycorrhiza is used. In some embodiments, a mycorrhiza mixture is used in which the mixture contains at least 95 percent, or at least 97 percent endomycorrhiza content and the balance to achieve 100 percent is comprised of ectomycorrhiza content.

In some embodiments, the present compositions comprise arbuscular, ericoid, arbutoid, monotropoid, or orchid mycorrhizae. In some embodiments, the compositions comprise arbuscular mycorrhizal fungi. In some embodiments, the compositions comprise Glomeromycota fungi. In some embodiments, the compositions comprise mycorrhizae of the genus Acaulospora, Entrophospora, Gigaspora, Glomus, Rhizophagus, Sclerocystis or Scutellospora. In some embodiments, the endomycorrhiza content comprises any one of the following species of endomycorrhizal fungi: Rhizophagus Sp., Glomus Sp., Acaulospora Sp., Scutellospora Sp. and Glomus Sp. In some embodiments, the endomycorrhiza content comprises a mixture of the foregoing endomycorrhizal fungi.

In some embodiments, combinations of the foregoing endomycorrhiza are created to produce desired results in plant growth. Rhizophagus Sp. are able to penetrate the cells of the root to form tree-like structures (arbuscular) for the exchange of sugars and nutrients with the host plant and are highly efficient in nutrient-deficient soil. Glomus Sp. obtain carbon from the host plant in exchange for nutrients and other benefits, and help in soil detoxification processes (for example, detoxifying arsenic-laced soils). Examples of Glomus species include Glomus aggregatum, Glomus brasilianum, Glomus clarum, Glomus deserticola, Glomus etunicatum, Glomus fasciculatum, Glomus intraradices, Glomus monosporum, and Glomus mosseae. They also improve soil nodulation and nutrient uptake to the plant, increase the surface area for absorption of water, phosphorus, amino acids, and nitrogen, and are more resistant to certain soil-borne diseases. Acaulospora Sp. are able to interact with and change the environment in the favor of the host plants, improving soil structure and quality. Scutellospora Sp. create humic compounds, polysaccharides, and glycoproteins that bind soils, increase soil porosity, and promote aeration and water movement into the soil. Alternatively, yet other versions of endomycorrhizal fungi may be used.

Ectomycorrhizae typically form between the roots of woody plants and fungi belonging to the divisions Basidiomycota, Ascomycota, or Zygomycota. These are external mycorrhizas that form a cover on root surfaces and between the root's cortical cells. Besides the mantle formed by the mycorrhizae, most of the biomass of the fungus is found branching into the soil, with some extending to the apoplast, stopping short of the endodermis. Ectomycorrhizae are found in 10% of plant families, mostly woody species, including the oak, pine, eucalyptus, dipterocarp, and olive families. In some embodiments, the composition comprises ectomycorrhizae. In some embodiments, the ectomycorrhizae are of the phylum Basidiomycota. In some embodiments, the ectomycorrhizae comprise a strain of Laccaria bicolor, Laccaria laccata, Pisolithus tinctorius, Rhizopogon amylopogon, Rhizopogon fulvigleba, Rhizopogon luteolus, Rhizopogon villosui, Scleroderma cepa, or Scleroderma citrinum. In some embodiments, the ectomycorrhiza content comprises Pisolithus Sp., or others. Such ectomycorrhiza are efficient in uptake of inorganic and organic nutrient resources, and enhance the capability to utilize organic nitrogen sources efficiently. They further create structures that host nitrogen-fixing bacteria that contribute to the amount of nitrogen taken up by plants in nutrient-poor environments. They are also highly nickel-tolerant, and work efficiently in ultramafic soil.

In some embodiments, the mycorrhizae are ericoid mycorrhizae. In some embodiments, the mycorrhizae are of the phylum Ascomycota, such as Hymenoscyphous ericae or Oidiodendron sp. In some embodiments, the mycorrhiza are arbutoid mycorrhizae. In some embodiments, the mycorrhizae are of the phylum Basidiomycota. In some embodiments, the mycorrhizae are monotripoid mycorrhizae. In some embodiments, the mycorrhizae are of the phylum Basidiomycota. In some embodiments, the mycorrhizae are orchid mycorrhiza. In some embodiments, the mycorrhizae are of the genus Rhizoctonia.

The active component of the mycorrhiza may be the spores, hyphae, extramatrix arbuscular mycelium, glomalin and rootlets, colonized by the fungus in question.

In some embodiments, the compositions of the present disclosure comprise a commercially available mycorrhizae powder. In some embodiments, the composition comprises mycorrhizae powder on an inert carrier, such as a sugar, starch, clay-based carrier, mineral-based carrier, or the like.

Mycorrhizal products comprise different elements of mycorrhizae. In some embodiments, products are characterized based on the quantity of infective propagules.

Propagules include spores, vesicles, pieces of mycelium, and colonized roots. In some embodiments, the mycorrhizae is quantified in terms of number of spores. In some embodiments, the mycorrhizae has a concentration of 100 to 10,000 infective spores per gram. In some embodiments, the mycorrhizae has a concentration of 300 to 6,000 infective spores per gram. Mycorrhizae may also be quantified based on propagules. In some embodiments, a mycorrhizae composition comprises 50 to 50,000 infectivity propagules per gram. In some embodiments, the mycorrhizae has 80-6,000 infectivity propagules per gram.

In some embodiments, a composition of the disclosure comprises 0.5-5.0% w/w mycorrhizae powder. In some embodiments, a composition of the disclosure comprises about 0.5-500 spores/gram. In some embodiments, a composition of the disclosure comprises about 10-300 spores/gram. In some embodiments, a composition of the disclosure is formulated to comprise 10,000-2,000,000 spores per amount to be distributed to one hectare. For example, in some embodiments where 10 kg of composition are to be distributed per one hectare, the composition comprises 5,000-200,000 spores per kg.

### Diazotrophic Bacteria

The ability of specific bacterial species to promote plant growth has long been recognized. For example, nitrogen-fixing bacteria such as Rhizobium species provide plants with essential nitrogenous compounds. Species of Azotobacter and Azospirillum have also been shown to promote plant growth and increase crop yield, promoting the accumulation of nutrients in plants.

In some embodiments, a composition of the disclosure comprises plant-beneficial bacteria. In some embodiments, the composition comprises nitrogen-fixing, i.e., diazotrophic, bacteria. In some embodiments, the composition comprises symbiotic diazotrophic bacteria. In some embodiments, the composition comprises gram positive or gram negative diazotrophic bacteria.

In some embodiments, a composition of the disclosure comprises a bacterium of the genus Anabaena, Azoarcus, Azorhizobium, Azospirillum, Azotobacter, Bacillus, Bradyrhizobium, Burkholderia, Clostridium, Frankia, Gluconacetobacter, Herbaspirillum, Klebsiella, Mesorhizobium, Nitrosospira, Nostoc, Paenibacillus, Parasponia, Pseudomonas, Rhizobium, Rhodobacter, Sinorhizobium, Spirillum, and Xanthomonus. Additional genera and species of plant beneficial bacteria are known in the art. See, e.g., U.S. Patent Publication Nos. 2014/0256547, 2015/0239789, 2016/0100587, and 2019/0124917, each of which is incorporated by reference herein in its entirety.

In some embodiments, the composition comprises a diazotrophic bacterium of the genus Bacillus, Rhizobium, Bradyrhizobium, or Azospirillum. Examples of species for inclusion in the compositions of the disclosure include: Azospirillum lipoferum, Azospirillum brasilense, Azospirillum amazonense, Azospirillum halopraeferens, Azospirillum irakense, Bacillus itcheniformis, Bacillus megaterium, Bacillus pumilus, Bacillus amyloliquefaciens, Bacillus licheniformis, Bacillus oleronius, Bacillus megaterium, Bacillus mojavensis, Bacillus pumilus, Bacillus subtilis, Bacillus circulans, Bacillus globisporus, Bacillus firmus, Bacillus thuringiensis, Bacillus cereus, Bradyrhizobium japonicum, Bradyrhizobium elkanii, or Bradyrhizobium diazoefficiens, and Rhizobium meliloti. In some embodiments, the composition comprises Bradyrhizobium japonicum.

In some embodiments, a composition of the present disclosure includes a diazotrophic bacterium, i.e., the bacterium is mixed with the CFS and microalgae and/or mycorrhizae. In some embodiments, a composition of the present disclosure is administered alongside a diazotrophic bacterium, i.e., simultaneously with, shortly after, or shortly before administration of the diazotrophic bacterium.

### Carriers

In some embodiments, the composition comprises a solid substrate or carrier. In some embodiments, carrier granules are prepared as a substrate or carrier for the combined solution.

In some embodiments, granules are prepared prior to the mixture of the solution, or simultaneous with or after the solution preparation. In some embodiments, the carrier is a natural clay granule or mineral- or organic-based granule. In some embodiments, the carrier is limestone, silica, talc, kaolin, dolomite, calcium sulfate, calcium carbonate, magnesium sulfate, magnesium carbonate, magnesium oxide, diatomaceous earth, zeolite, bentonite, dolomite, leonardite, attapulgite, trehalose, chitosan, shellac, pozzolan, diatomite, or diatomaceous earth, or any combination thereof. In some embodiments, the carrier is a solid substrate formed as granules or extruded pellets of other materials such as synthetic fertilizer.

In some embodiments, the granules have a diameter of about 1-10 mm. In some embodiments, the granules have a diameter of about 2-4 mm.

Natural clay based granules are inert, biodegradable, resistant to attrition due to mixing, and have a neutral pH. Accordingly, in some embodiments, the acidity of a coating solution is matched to that of the carrier prior to coating. Clay granules are available in several size grades from 12/25 mesh to 10/20 & 16/35 mesh (ASTM). A range of carrier sizes are suitable for use in some embodiments of the disclosure.

In some embodiments, the granules are formed from zeolite. Zeolite is a soil conditioner that can control and raise the pH of the soil and improve soil moisture. Synthetic and natural zeolites are hydrated aluminosilicates with symmetrically stacked alumina and silica tetrahedra which result in an open and stable three-dimensional honeycomb structure with a negative charge. The negative charge within the pores is neutralized by positively charged ions (cations) such as sodium. Their aluminosilicate frameworks allows them to be used as cationic exchangers because of their high cation exchange capacity (CEC) due to the presence of trivalent Al atoms in the zeolite framework which induce negative charges that are compensated by the presence of cations. In some embodiments, the zeolite is a natural zeolite. In some embodiments, the zeolite is a synthetic zeolite. In some embodiments, the zeolite is Clinoptilolite.

In some embodiments, the granules are formed from dolomite. Dolomite can be used for soil neutralization to correct acidity. Adding zeolite or dolomite to manure improves the nitrification process. These materials are commonly used as slow release substances for pesticides, herbicides and fungicides. In some embodiments, zeolite or dolomite particles, or combinations of the two, may be used for the carrier granules.

In some embodiments, attapulgite is used as the carrier granule. Attapulgite is a magnesium aluminum phyllosilicate which occurs in a type of clay soil, and it is used as a processing aid and functions as a natural bleaching clay for the purification of vegetable and animal oils. It is available in both colloidal and non-colloidal forms. In some embodiments, attapulgite particles or granules are used as carrier granules in the present compositions.

Leonardite is an oxidation product of lignite coal, mined from near surface pits. Leonardite is a high quality humic material soil conditioner which acts as a natural chelator. It is typically soft, dark colored, and vitreous, containing high concentrations of the active humic acid and fulvic acid. In some embodiments, leonardite is used, alone or in combination with other materials, as a carrier granule.

Bentonite pellets are used in agriculture for soil improvement, livestock feed additives, pesticide carriers, and other purposes. Bentonite mixed with chemical fertilizer can fix ammonia and can act as a buffer for fertilizers. The inherent characteristics of water retention and absorbency makes it an ideal addition to improve the fertility of soil. The prevalence of sandy soil in many regions that suffer from low water and nutrient holding characteristics, can be significantly enhanced by the addition and blending of calcined bentonite. In some embodiments, bentonite, or calcined bentonite, is used as a carrier granule.

In some embodiments, the carrier granules comprise a mix of different materials such as clay, leonardite, attapulgite, zeolite, and/or bentonite.

In some embodiments, the composition comprises more than 50% w/w solid carrier. In some embodiments, the composition comprises more than 70, 80, 90, or 95% w/w solid carrier. In some embodiments, the composition comprises about 80-95% w/w solid carrier.

In some embodiments, the composition comprises a liquid carrier. Non-limiting examples of liquids useful as carriers for compositions disclosed herein include water, an aqueous solution, or a non-aqueous solution. In some embodiments, a carrier is water. In some embodiments, a carrier is an aqueous solution. In some embodiments, a carrier is a non-aqueous solution. For example, in embodiment involving a soil drench, foliar spray, or other liquid composition, suitable liquid carriers include water, buffered water, and oils.

In some embodiments, the composition comprises more than about 90% w/w liquid carrier. In some embodiments, the composition comprises about 95-99.9% w/w liquid carrier. In some embodiments, the composition comprise about 99.5-99.7% w/w liquid carrier.

### Additional Ingredients

In some embodiments, the composition comprises ingredients in addition to microalgae and mycorrhizae components. In some embodiments, the composition comprises an excipient, surfactant, diluent, binder, disintegrant, inert filler, pH stabilizer, spreader, fixative, defoamer, carrier, antimicrobial agent, fertilizer, nutrient composition, pesticide, herbicide, fungicide, insecticide, nematicide, molluscicide, antifreeze agent, antioxidant, preservative, or anti-aggregation agent. One of ordinary skill in the art will appreciate that additional agrochemically acceptable excipients are available for inclusion in the present compositions without departing from the scope of the disclosure. Agriculturally acceptable excipients are commercially manufactured and available through a variety of companies.

In some embodiments, the composition comprises a binder. In some embodiments, the composition comprises a hydrocolloid. In some embodiments, the composition comprises a vinasse, lignosulfonate, cellulose, anhydrite, sugar, starch, or clay.

In some embodiments, the composition is mixed with one of the aforementioned additional ingredients. In some embodiments, the composition is administered at the same time as one of the aforementioned additional ingredients. In some embodiments, the composition is administered shortly before or shortly after one of the aforementioned additional ingredients.

### Exemplary Formulations of the Disclosure

The present disclosure provides agricultural compositions in the form of granules or liquid formulations comprising CFS and microalgae and/or mycorrhizae for use in improving one or more plant parameters.

### Methods of Formulating Granule Compositions

The present invention is directed to compositions comprising CFS and microalgae and/or mycorrhizae. The components may be combined in the composition by any suitable means. In some embodiments, the composition is a granule formulation comprising 0.5-5.0% w/w CFS, and 0.5-5.0% w/w DMS and/or 0.5-5.0% w/w mycorrhizae. In some embodiments, the composition comprises 0.5-5.0% w/w CFS. In some embodiments, the composition comprises 0.05-0.5% w/w microalgae dry matter. In some embodiments, the composition comprises 0.5-500 mycorrhizae spores/gram.

In some embodiments, the components of the composition are suspended in a liquid coating solution before being applied to a granule carrier. The granule carrier may be any of the solid carriers describe herein. In some embodiments, the liquid coating solution comprises water and one or more buffers. In some embodiments, a buffered CFS and a buffered microalgae solution and/or a buffered mycorrhizae solution are prepared together. In some embodiments, the buffered solutions are prepared separately. In some embodiments, CFS and/or DMS may have an acidic pH, e.g., below pH 4, while mycorrhizae solution has a pH of greater than 7. In some embodiments, to improve the mixing of the components of the composition, without negatively impacting the viability of the mycorrhizae, coating solutions of each component are prepared separately, adjusted to a similar pH level, then combined with a solid carrier.

In some embodiments, the buffered coating solution comprising CFS and the buffered coating solution comprising microalgae and/or the buffered coating solution comprising mycorrhizae are combined after separate preparation. The coating solutions may be mixed by any suitable means. In some embodiments, the combined coating solution is mixed using a mixing stirrer in an appropriate vessel. In some embodiments, the ingredients are mixed for between one and thirty minutes using either stirring or agitation.

In some embodiments, the buffered solutions are in the range of pH 5-7. In some embodiments, the buffered solutions are in the range of pH 6.0-6.5. Any suitable buffers may be used for adjusting the pH of the coating solution(s). Examples of suitable buffers include citrate buffer and phosphate buffer. In some embodiments, as needed, an amount of NaOH or HCl or other acids or bases are added to the mycorrhiza solution or the microalgae solution for the purpose of adjusting the pH level of the solutions to the final desired pH level, e.g., in the range of pH 6.0 to 6.5.

In some embodiments, the coating solution(s) are added to the solid carrier granules. In embodiments with separate coating solutions, the coating solutions may be added to the granules one after the other or simultaneously. In some embodiments, the solid carrier granules are dried after application of the coating solution(s). Means of drying the granules include drying at ambient temperature, drying via sunlight, drying via heat lamp, drying via sodium lamp, baking, dessicating, and the like.

In some embodiments, the amount of coating solution, i.e., the amount of buffer and/or water added to the CFS and microalgae and/or mycorrhizae components, is determined based on the moisture capacity of the solid carrier. In some embodiments, the coating solution is 5-20% w/w of the combined weight of the coating solution plus solid carrier. In some embodiments, the amount of liquid coating solution does not exceed the absorbent capacity of the solid carrier. In some embodiments, the solid carrier makes up about 80% to about 95% w/w of the granules.

A coating solution described herein may be added to a carrier granule by any suitable means. In some embodiments, the coating solution(s) are sprayed onto the carrier granules or other desired substrate, e.g., with the use of sprayer nozzles, spray dryers, rotary drums, booth mixing blenders, and the like. Blending of the granules and the coating solution may occur by any suitable means, e.g., tumbling, shaking, or other agitation.

In some embodiments, the granules are dried at ambient temperature or under a heater or dryer, such as a sodium lamp, before packing to avoid any moisture formation in final packed product. In some embodiments, drying occurs for at least 30 minutes and drying reaches a moisture level of 12 percent or less. In order to achieve the 12 percent concentration, in one version the initial moisture concentration of the granule is at six percent or less. Throughout the process, demineralized water may be added as necessary to produce the final moisture concentration level.

Granules may be screened before, during, or after coating to select for granules of a desired particle size. In some embodiments, the granules are screened using one or more mesh screens. After blending, drying, and optional screening, the granules may be transferred to a silo or other storage tank for later packaging, processing, or use.

### Granules

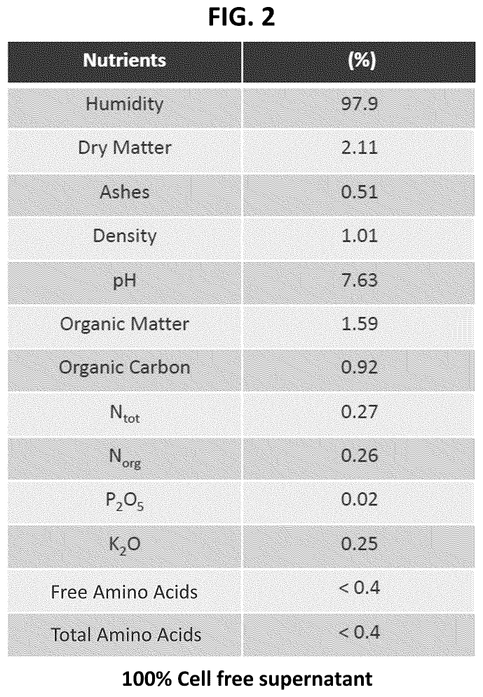

The present disclosure provides agricultural granule compositions comprising CFS and microalgae and/or mycorrhizae. In some embodiments, the composition comprises about 0.5% to about 5.0% w/w CFS. In some embodiments, the composition comprises about 0.5%-5.0% of CFS having, e.g., the nutritional profile disclosed in FIG. 2.

In some embodiments, the composition comprises from about 0.5% to about 5.0% w/w digested microalgae solution (“DMS”). In terms of dry matter, in some embodiments, the composition comprises from about 0.05% to about 0.5% dry matter of microalgae. In some embodiments, the composition comprises about 0.5-5.0% w/w of the ingredients of DMS, e.g., as in FIG. 1A. In some embodiments, the composition comprises up to 5% w/w dry matter of microalgae.

In some embodiments, the granule composition comprises from about 0.5% to about 5.0% w/w mycorrhizae using a powder comprising the mycorrhizae. In some embodiments, the powder comprises 100-10,000 spores/gram. In some embodiments, the granule composition comprises 0.5-500 spores/gram. In some embodiments, the composition comprises 5-500 spores/gram. In some embodiments, the composition comprises 10-300 spores/gram.

In some embodiments, the granule composition is formulated with 0.5-5.0% w/w CFS and 0.5-5.0% w/w DMS and/or 0.5-5.0% mycorrhizae mixed with sufficient quantity of water, e.g., demineralized water, to provide moisture content less than or equal to the absorbent capacity of the solid carrier. In some embodiments, the moisture content is less than or equal to 20%, 15%, 10%, 5% or 1%. For example, in some embodiments, the moisture content is less than or equal to 12% w/w. In some embodiments, the composition comprises more than 50% of a solid carrier. In some embodiments, the composition comprises about 80% to about 95% w/w of a natural clay-based carrier, mineral-based carrier, or other solid substrate such as extruded pellets of organic composition or granules of mineral or synthetic fertilizer. In some embodiments, the composition comprises about 80-95% w/w zeolite or bentonite.

### Liquid Formulations

The present disclosure provides liquid agricultural compositions comprising CFS and microalgae. In some embodiments, the liquid formulation comprises CFS and DMS. In some embodiments, the ratio of the CFS to the DMS varies. In some embodiments, the liquid formulation comprises 10-90% w/w CFS and 10-90% w/w DMS. In some embodiments, the liquid formulation comprises 20-80% w/w CFS and 20-80% w/w DMS. In some embodiments, the liquid formulation comprises about 80% w/w CFS and about 20% w/w DMS. In some embodiments, the liquid formulation comprises about 60% w/w CFS and about 40% w/w DMS.

In some embodiments, the liquid formulation comprising CFS and DMS is diluted in water prior to application, e.g., demineralized water. In some embodiments, the liquid formulation is diluted to 0.1%-1.0% v/v in water before application. In some embodiments, the liquid formulation is diluted to 0.3%-0.5% v/v in water before application. During dilution, fertilizer and/or nutrient supplementation may be added to the composition along with water.

In some embodiments, the liquid formulation comprises 10-90% w/w CFS and comprises about 0.5-30 g/L of whole-cell microalgae powder. In some embodiments, the liquid formulation comprises 60-80% w/w CFS and comprises about 0.8-20 g/L of whole-cell microalgae powder.

### Methods of Using Compositions Comprising Microalgae and Mycorrhizae

The present disclosure provides methods of using the compositions described herein on an agricultural crop.

### Agricultural Crops

The methods of the present disclosure may be used on any agricultural crop. Agricultural crops include agronomic crops, horticultural crops, and ornamental plants. In some embodiments, a method of the present disclosure is employed on an agronomical crop selected from the list consisting of wheat, rice, corn, soybean, alfalfa, forage crops, beans, sugar beets, canola, and cotton. In some embodiments, a method of the disclosure is employed on a horticultural crop selected from the list consisting of vegetables, fruits, flowers, ornamentals, and lawn grasses. In some embodiments, a method of the disclosure is employed on an ornamental plant selected from the list consisting of flowers, shrubs, grasses, and trees.

Agricultural crops include both monocots and dicots. In some embodiments, the methods of the disclosure are employed on monocots, such as agapanthus, asparagus, bamboo, bananas, com, daffodils, garlic, ginger, grass, lilies, onions, orchids, rice, sugarcane, tulips, and wheat. In some embodiments, the methods of the disclosure are employed on dicots, such as apples, beans, broccoli, carrots, cauliflower, cosmos, daisies, peaches, peppers, potatoes, roses, sweet pea, and tomatoes. In some embodiments, the agricultural crop is a food crops, feed crop, cereal crop, oil seed crop, pulse, fiber crop, sugar crop, forage crop, medicinal crop, root crop, tuber crop, vegetable crop, fruit crop, or garden crop.

Compositions of the present invention may be applied to any plant or plant propagation material that may benefit from improved growth including agricultural crops, annual grasses, trees, shrubs, ornamental flowers and the like.

In some embodiments, the agricultural crop is selected from cereals, plantation crops, groundnut crops, grams, pulses, vegetables, fruits, proteaginous crops, citrus crops, berry crops, melon crops, vine crops. In some embodiments, the agricultural crop is selected from the list consisting of apple, barley, sunflower, plum, rice, paddy rice, agave, strawberry, watermelon, coffee, tomato, lentil, pea, chickpea, potato, cotton, sugarcane, wheat, banana, soybean, corn, sorghum, onion, carrot, bean, zucchini, lettuce, chicory, fennel, sweet pepper, pear, peach, cherry, kiwifruit, soft wheat, durum wheat, grapevine, table grape, olive, almond, hazelnut, cotton, canola, and maize.

### Application Methods and Application Rates

In some embodiments, the methods comprise applying a dry granule formulation as described herein. The dry granule formulation can be applied to the crops by any suitable means. In some embodiments, the granules are broadcast onto the soil, e.g., by hand or by machine. In some embodiments, the granules are pre-mixed with sand, soil, and/or fertilizer before broadcast. In some embodiments, the compositions are spread, brushed, or sprayed onto the crops or the environs thereof by hand, by apparatus, or by machine. In some embodiments, the dry granule formulation is applied at the rate of 1-100 kg per hectare. In some embodiments, the dry granule formulation is applied at the rate of 5-50 kg per hectare. In some embodiments, the dry granule formulation is applied at the rate of about 10 kg per hectare.

In some embodiments, the present methods comprise applying a seed coating as described herein. In some embodiments, the seed coating is applied to the seeds before planting, e.g., using a mixer. In some embodiments, the seed coating is applied in furrow, e.g., via suitable broadcast or in-furrow application means. In some embodiments, the seed coating is applied using flow equipment after suspension in a liquid carrier. In some embodiments, the seed coating is applied at the rate of about 10 g to 1 kg of dry powder seed coating per quantity of seeds to be planted in one hectare. In some embodiments, the seed coating is applied at the rate of about 50-200 g of dry powder seed coating per quantity of seeds to be planted in one hectare. In some embodiments, the seed coating is applied at the rate of about 100 g of dry powder seed coating per quantity of seeds to be planted in one hectare.

In some embodiments, the present methods comprise applying a liquid formulation as described herein. In some embodiments, the liquid formulation is applied at a rate of 100 mL to 100 L per hectare. In some embodiments, the liquid formulation is applied at a rate of 0.5 L to 10 L per hectare. In some embodiments, the liquid formulation is applied at a rate of about 4-7 L per hectare. In some embodiments, the liquid formulations herein are diluted in water or a suitable liquid carrier prior to application. For example, In some embodiments, the liquid formulations are diluted to 0.1-1.0% v/v before application to the host plant, plant parts, or plant environs. In some embodiments, the liquid formulations are diluted to 0.3-0.5% v/v before application.

The compositions of the present disclosure may be applied to any part of a host plant or the environs thereof. In some embodiments, in the case of granules, the compositions are applied to the roots and/or the soil around the host plant. In some embodiments, in the case of seed coatings, the compositions are applied to the seeds of the host plant before, during or shortly after planting. In the case of liquid compositions, the compositions may be applied to the seeds, seedlings, plants, or plant parts. Plant parts include seeds, seedlings, plant tissues, leaves, branches, stems, bulbs, tubers, roots, root hairs, rhizomes, cuttings, flowers, and fruits. Compositions of the present invention may further be applied to any area where a plant will grow including soil, a plant root zone and a furrow.

The compositions of the present disclosure can be applied at any time during the host plant life cycle. In some embodiments, the compositions of the present disclosure are applied shortly after planting, tillering, or sowing. In some embodiments, the compositions of the present disclosure are applied as a seed coating or soil treatment around the time of planting. In some embodiments, the compositions are applied 0-30 days after planting, sowing, or tillering. In some embodiments, the compositions are applied pre-blooming. In some embodiments, the compositions are applied post-blooming. In some embodiments, the compositions are applied at rooting, sprouting, flowering, fruit setting, ripening, or fattening, in some embodiments, the compositions are applied before or during a peak period of metabolic activity. In some embodiments, the compositions are applied during a period of host plant stress.

In some embodiments, the compositions are applied more than once. In some embodiments, the composition is administered 3 to 5 times per growing cycle, depending on the type of crop, the intensity, and the planting. In some embodiments, the compositions are applied periodically throughout the growing cycle. The compositions may be applied once a day, once a week, once every two weeks, or once a month. In some embodiments, the timing of composition application is based on field studies assessing the efficacy of application at different time points. In some embodiments, the compositions are applied 1-10 times throughout the growing cycle of the host plant. In some embodiments, the compositions are applied 1-5 times throughout the growing cycle of the host plant.

In some embodiments, application to plants, plant parts, plant tissues, or plant environs comprises soil application pre-blooming and application to aerial biomass post-blooming. In some embodiments, compositions intended for soil are applied pre-blooming, such as granules or liquid soil treatments, and compositions intended for aerial dispersion are applied post-blooming, such as foliar sprays.

### Improving Growing, Production, or Biostimulant Parameters

The present disclosure provides methods for improving a growing parameter, production parameter, or biostimulant parameter of a host plant. The methods comprise applying a composition of the present disclosure to the host plant.

In some embodiments, the method increases a growing parameter of the host plant. A growing parameter is related to the growth of the host plant. Growing parameters include plant size, biomass (dry or wet), aerial biomass, height, number of branches, number of leaves, number of flowers, root biomass, number of roots, number of secondary roots, root volume, root length, and degree of inoculation by diazotrophic bacteria.

In some embodiments, the method increases a production parameter of the host plant. A production parameter is related to the plant part that is harvested from the plant for commercial purposes. Production parameters include, but are not limited to, yield, yield per plant, yield per area, harvested biomass, harvested weight, harvested volume, number of harvested plant parts, and size of harvested plant parts. In terms of the harvestable plant parts, production parameters include yield, weight, size, and number of harvestable plant parts. Harvestable plant parts include, for example, fruits, vegetables, roots, grains, tubers, leaves, flowers, seeds, and nuts. In some embodiments, e.g., for some grasses, lettuces, feed crops, and forage crops, a harvestable plant part is the entire aerial biomass of the plant. In some embodiments, the harvestable plant part is related to the intended use of the crop. For example, for oil crops, the harvestable plant parts are the components of the plant containing the oil to be harvested.

In some embodiments, the method increases a biostimulant parameter of the host plant. Biostimulant parameters include, but are not limited to, chlorophyl content, carotenoid content, micronutrient profile, and macronutrient profile. In some embodiments, the method increases the concentration of a chlorophyl, e.g., chlorophyl a or chlorophyl b. In some embodiments, the method increases the concentration of a carotenoid or improves the average carotenoid profile. In some embodiments, the method increases the micro and/or macro-nutrient profile of the harvested plant part, the plant leaves, or the plant roots. In some embodiments, the method increases the concentration of one or more micronutrients or one or more macronutrients in the roots, leaves, or fruits of the host plant. In some embodiments, the method increases the nitrogen content in the leaves of the host plant. Nitrogen stimulates plant growth and is directly related to the root system's ability to fix nitrogen and the host plant's nitrogen metabolism. In some embodiments, the method increases the concentration of magnesium, manganese, copper, or potassium in the roots. Manganese and Copper are highly effective micronutrients in plant resistance to diseases (Marschner, 2012). By affecting cell wall composition and lignin synthesis Mn and Cu suppress penetration of pathogens into plant tissue. Increases in chlorophyl content depend on Mg supply (Marschner, 2012). Plant Stem Growth is very sensitive to potassium concentration. Plant height increase can be related to potassium concentration in the root system. Potassium is also involved in tree growth and wood formation. In the cambial region and the xylem differention zone, a strong potassium demand has been shown. Differentiating xylem cells involved in wood formation represent a strong sink for potassium that provides the driving force for cell expansion (Langer et al., 2002; Plant Journal, 32: 997-1009).

In some embodiments, the method improves a growing parameter, production parameter, or biostimulant parameter compared to a control condition. In some embodiments, the method improves a parameter in terms of timing, i.e., the parameter is improved at a given time point compared to the control. For example, In some embodiments, the method may improve a growing parameter relative to a control early on, such as early flowering, faster maturation, increased height compared to control at the same time point.

In some embodiments, the methods yield synergistic improvements from the combination composition on a parameter of a host plant compared to the improvements yielded by any one of the components of the composition alone.

The inventors have surprisingly observed that methods comprising application of the combination of DMS and CFS have resulted in an improved growing, production, or biostimulant parameter at a lower dosage: e.g., in some embodiments, application of a DMS/CFS composition at 2 L/ha surprisingly outperformed or performed equally as well as application of the same product at 4 L/ha or 6 L/ha. In some embodiments, the lower dosage of the combination composition outperformed a higher dosage of each component applied individually. These results suggest a synergistic improvement from the combination of DMS and CFS. In some embodiments, the parameter that is improved is any one of the growing, production, or biostimulant parameters disclosed herein. In some embodiments, the parameter that is improved at a lower dosage is number of fruit, fruit weight, root mass, and/or plant biomass.

### Improvements in Host Plant Response to Abiotic Stress

The present disclosure provides methods of improving an agricultural crop's tolerance to abiotic stress.

Abiotic stress includes water stress, temperature stress, sun stress, salinity stress, wind stress, and heavy metal stress. Examples of abiotic stress include drought, heat, cold, excess salinity, strong winds, heavy metals, flooding, and excessive sunlight.

In some embodiments, the present methods improve resistance to abiotic stress. In some embodiments, the present methods improve resistance to temperature stress. In some embodiments, the present methods improve resistance to water stress. In some embodiments, the present methods improve resistance to salinity stress. In some embodiments, the present methods improve resistance to sun stress. In some embodiments, the present methods improve resistance to wind stress. In some embodiments, the present methods improve resistance to heavy metal stress.

### Examples

### Example 1: Formulation of Illustrative Components of Compositions of the Disclosure

Whole-cell microalgae powder. A microalgae consortium comprising genera from the list of Chlorella, Scenedesmus, Nannochloropsis, Muriellopsis, Isochrysis, Tisochrysis, Desmodesmus, Haematococcus, Arthrospira, and Anabaena was cultured in photobioreactors supplemented with nutrients and CO₂. The microalgae were harvested once the biomass reached 0.5-5.0 g/L. Culture solids comprising whole microalgae cells were then separated from solution, dried, and ground to an average particle size of about 100-1000 microns in order to produce a mostly whole cell powder form of microalgae, i.e., “whole-cell microalgae powder.”

Digested microalgae solution. The whole cell microalgae powder was then processed to degrade cell walls and proteins, thereby increasing the concentration of accessible organic carbon, amino acids and peptides and producing a digested microalgae solution (“DMS”) of the disclosure. A nutrient analysis of an illustrative DMS is shown in FIG. 1A.

Liquid microalgae applications. For liquid microalgae applications, e.g., in the form of foliar sprays, the DMS was typically diluted to 0.3-0.5% v/v with demineralized water and optionally a buffer.

Microbial culture cell-free supernatant. Microbial consortia such as IN-M1 deposited with ATCC Patent Deposit No. PTA-12383 or IN-M2 deposited with ATCC Deposit No. PTA-121556 were cultured as described in U.S. Pat. Nos. 10,588,320 and 10,561,149, incorporated by reference herein in their entireties. Cell-free supernatant (“CFS”) was obtained by centrifuging the microbial culture for at least 10 minutes at a centrifugal force of about 14,000 g. The CFS composition was then checked by absorbance (600 nm) to determine whether any microbes were still present and the liquid portion was removed via decanting or pipetting. The supernatant was then filter sterilized with a 0.22 μM micron filter.

The chemical characterizations of the cell-free supernatant compositions made from microbial cultures comprising IN-M1 and IN-M2 were determined. The cell-free supernatant compositions had fairly high levels of potassium (about 2500 μg per gram of composition), followed by nitrogen (435-600 μg per g composition), calcium (475-660 μg per g composition) and magnesium (200-260 μg per g composition). Sodium ranged from 160 to 360 ppm. The pH ranges were similar at 4.3-4.5. Sulphur was present at near 425-500 ppm in the cell-free supernatant compositions tested. Phosphorus was present in very low levels (50-90 ppm). All other metals were at trace levels, except iron which was present at about 20 ppm. An analysis of an illustrative cell-free supernatant is presented in FIG. 2.

Mycorrhizae. A powdered composition comprising mycorrhizal fungi (“mycorrhizae”) was provided. The powder comprised 100-10,000 spores/g, along with inert ingredients, such as clay-based or mineral-based carriers, e.g., zeolite, and/or starch, e.g., dextrin, and/or sugars, among other inert ingredients known in the art.

### Example 2: Formulation of Illustrative Combined Digested Microalgae Solution and Cell Free Supernatant Compositions of the Disclosure

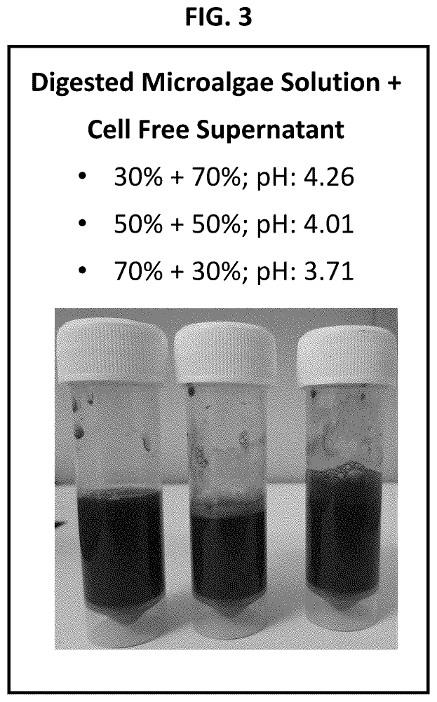

DMS and CFS were formulated according to Example 1. These components were mixed in various ratios of DMS to CFS, with nutrient analysis of each one presented in FIG. 1B-1E: 79%/21% (FIG. 1B), 50%/50% (FIG. 1C), 40%/60% (FIG. 1D), and 30%/70% (FIG. 1E). Three illustrative combinations are pictured in FIG. 3, along with their pH values, demonstrating that the combinations were stable and did not precipitate.

For application to agricultural crops, such combinations of DMS and CFS can be diluted to 0.3%-0.5% v/v with water separately or after combination.

### Example 3: Prophetic Formulation of Illustrative Combined Arbuscular Mycorrhizal Fungi and Cell Free Supernatant Compositions of the Disclosure

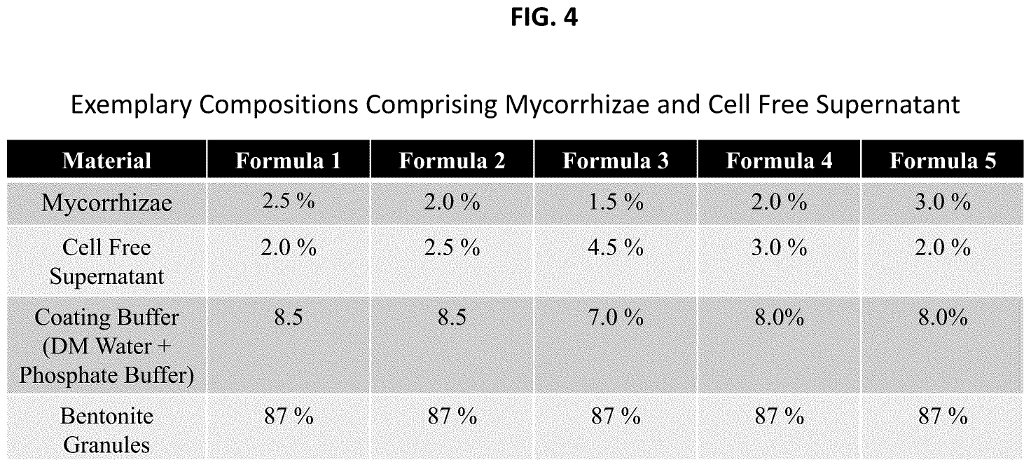

CFS is formulated as in Example 1 and is combined with the mycorrhizae powder described in Example 1, along with coating buffer. The coating buffer comprises demineralized water and phosphate buffer (e.g., 0.1 M phosphate buffer), and the combination of ingredients is adjusted to a pH of 6.0-6.5. This coating solution is sprayed and/or applied to bentonite granules, which are then dried. The percentages of each component by weight are shown in FIG. 4.

The granules comprise 1.5-3.0% w/w mycorrhizae powder, e.g., about 1-300 spores of mycorrhizae per gram of composition, and the granules comprise 2.0-4.5% of the components of CFS, e.g., 2.0-4.5% of the values in FIG. 2.

### Example 4: Formulation of Illustrative Combined Mycorrhizae, Digested Microalgae Solution, and Cell Free Supernatant Compositions of the Disclosure

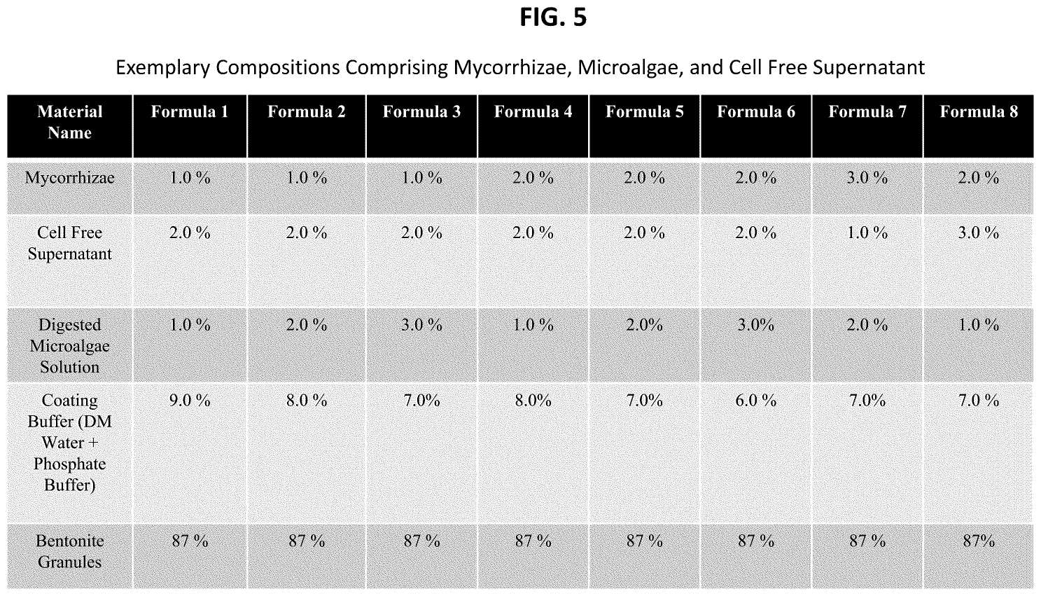

DMS is generated according to Example 1 and the pH is adjusted to 6.0-6.5 with a buffer. CFS and mycorrhizae are also as described in Example 1. All three components are added to a coating buffer comprising demineralized water and a buffer, e.g., 0.1 M phosphate buffer, and brought to a pH range of 6.0-6.5. This coating solution is sprayed and/or applied to bentonite granules, which are then dried. The percentages of each component by weight are shown in FIG. 5.

The granules comprise 1.0-3.0% w/w mycorrhizae, e.g., 1-300 spores of mycorrhizae/gram; 1.0-3.0% w/w buffered DMS, e.g., approximately 0.5-1.5% of the values in FIG. 1A; and comprise 1.0-3.0% w/w of the components of CFS, e.g., 1.0-3.0% of the values in FIG. 2.

### Example 5: Field Trials in Soybean and Corn of Illustrative Combination Composition of the Disclosure Comprising Digested Microalgae Solution and Cell Free Supernatant

### Materials and Methods

A combination of 20% DMS and 80% CFS was formulated as in Example 2. The combination composition was applied to the soil at a rate of 1 L/ha to soybeans, 1 L/ha to corn, and 3 L/ha to coffee, at pre-blooming stage in all three crops. The combination composition was diluted to 0.3%-0.5% v/v in water before application. All conditions also received grower standard treatment, and were compared to control with grower standard alone.

### Results

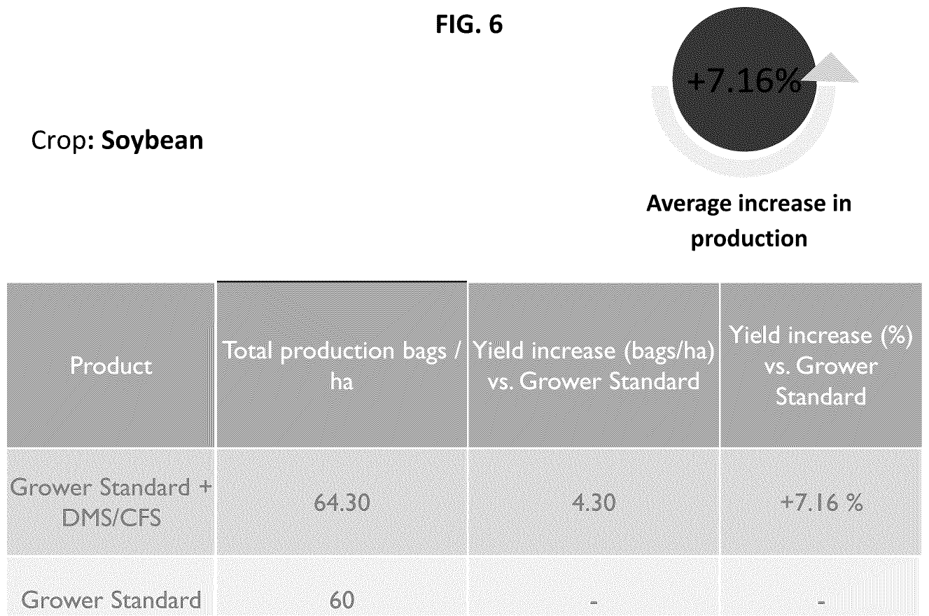

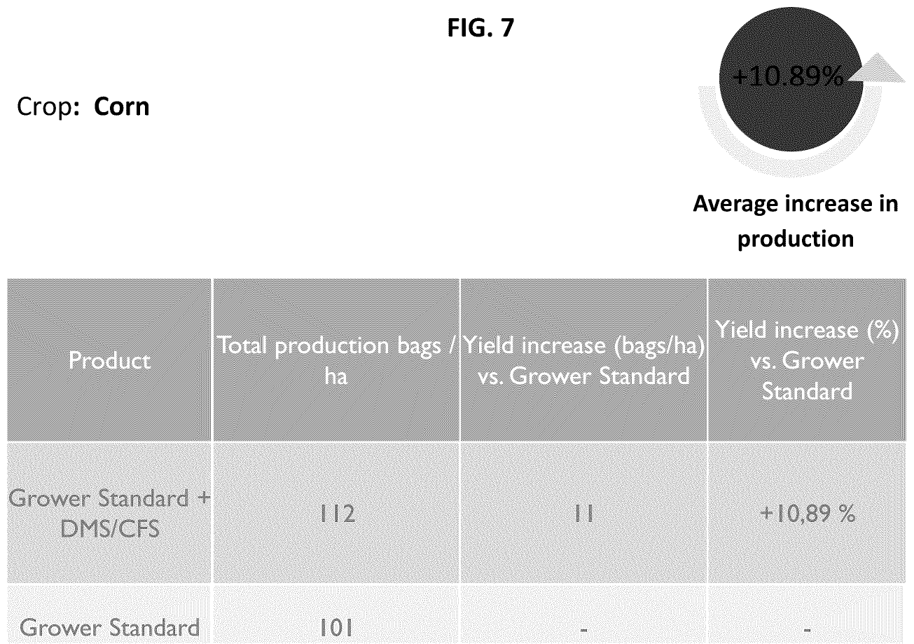

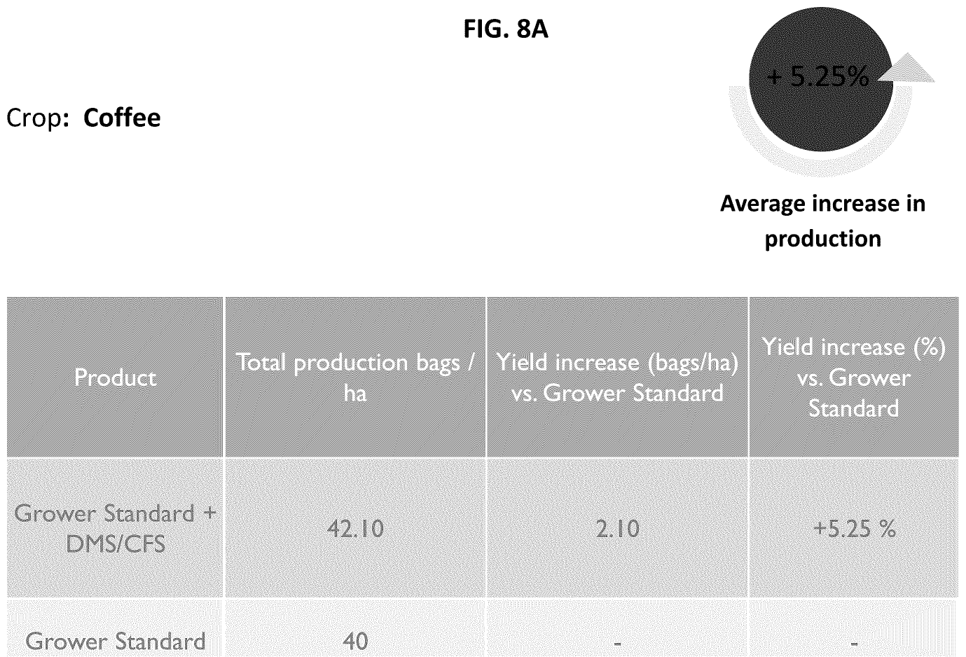

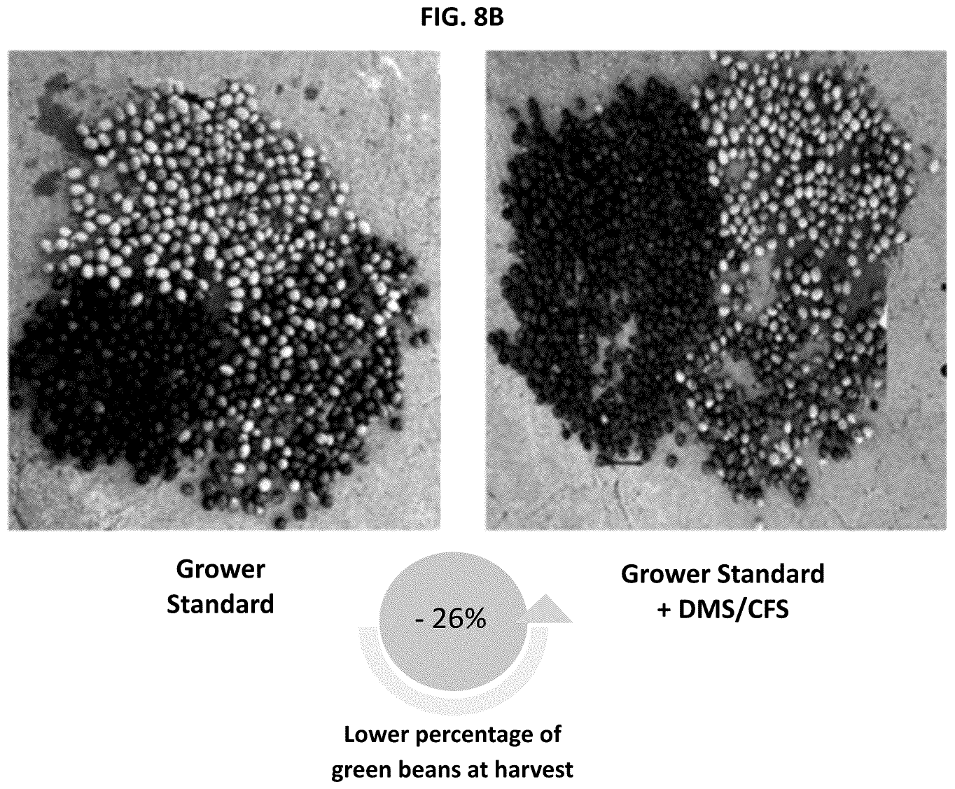

The results of these applications are shown in FIG. 6 (soybean), FIG. 7 (corn), and FIG. 8A-8B (coffee). In soybean, the application of this combination composition resulted in a 7.16% average increase in yield. In corn, a 10.89% increase in yield was observed. In coffee, this combination elicited a 5.25% increase in yield and remarkably decreased the number of green beans at harvest by 26%.

### Example 6: Greenhouse Trials in Tomato and Lettuce of Illustrative Combination Compositions of the Disclosure Comprising Digested Microalgae Solution and Cell Free Supernatant

### Materials and Methods

DMS and CFS were formulated as in Example 1. DMS and CFS were administered in the amounts shown in Table 1. The compositions were diluted to 0.3%-0.5% v/v in water before application. Six treatment conditions were applied to tomato and lettuce crops cultivated in greenhouse.

TABLE 1
Treatment conditions in greenhouse
trial of DMS and CFS combinations.

| Code | Treatment | Dosage | Application |
|---|---|---|---|
| T1 | Control | — | — |
| T2 | DMS alone | 4 L/ha DMS | Root |
| T3 | CFS alone | 2.5 L/ha CFS | Root |
| T4 | DMS + CFS | 4 L/ha DMS + 2.5 L/ha CFS | Root |
| T5 | DMS + CFS | 2 L/ha DMS + 1.25 L/ha CFS | Root |
| T6 | DMS + CFS | 1.6 L/ha DMS + 1.5 L/ha CFS | Root |

Treatments were applied on day 8, 15, and 22 after sowing. Plants were otherwise grown under typical conditions with 1 g/L nutrients (i.e., NPK fertilizer) added to half of the irrigations to avoid the appearance of nutritional deficiencies.

Sampling was performed on day 22 (first sampling) and day 30 after sowing (second sampling). During each sampling, the plants were photographed and assessed for aerial biomass, root biomass, number of flowers (tomato), and presence of fruit (tomato). At the second sampling, plants were also analyzed for photosynthetic pigments (chlorophyl A, chlorophyl b, and carotenoids), soluble proteins, and antioxidant capacity (FRAP).

### Results

In the graphical results, columns headed by the same letter belong to the same statistical range. Significance level: p-value>0.05=ns; p-value 0.05-0.01=*; p-value 0.01-0.001=**; p-value<0.001=***.

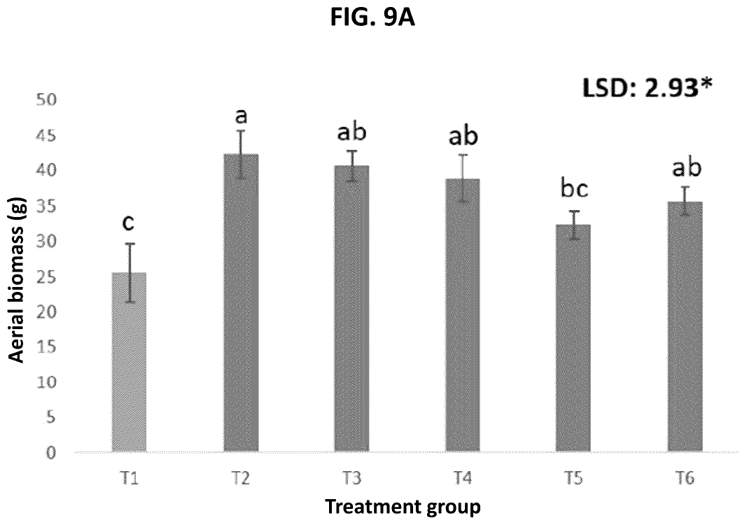

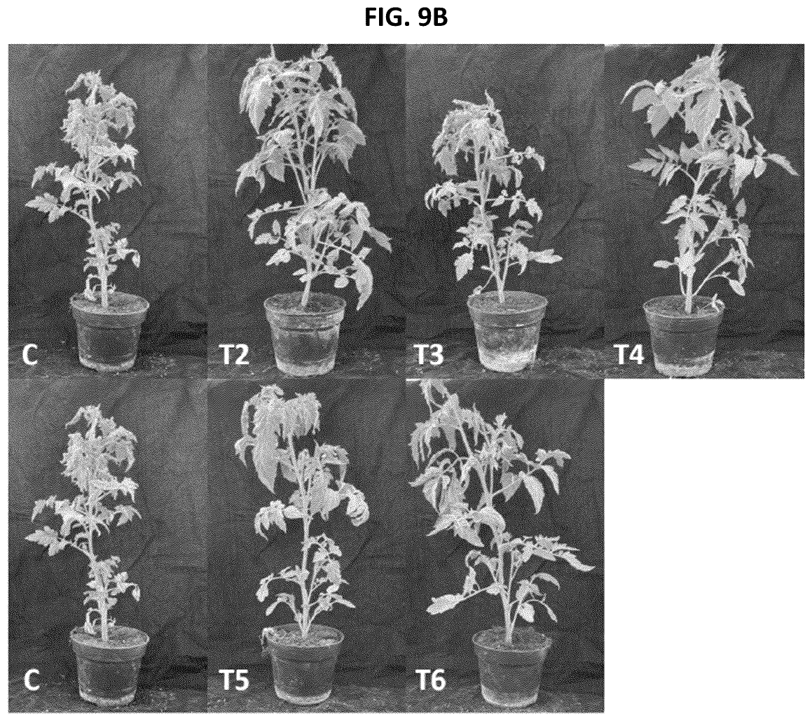

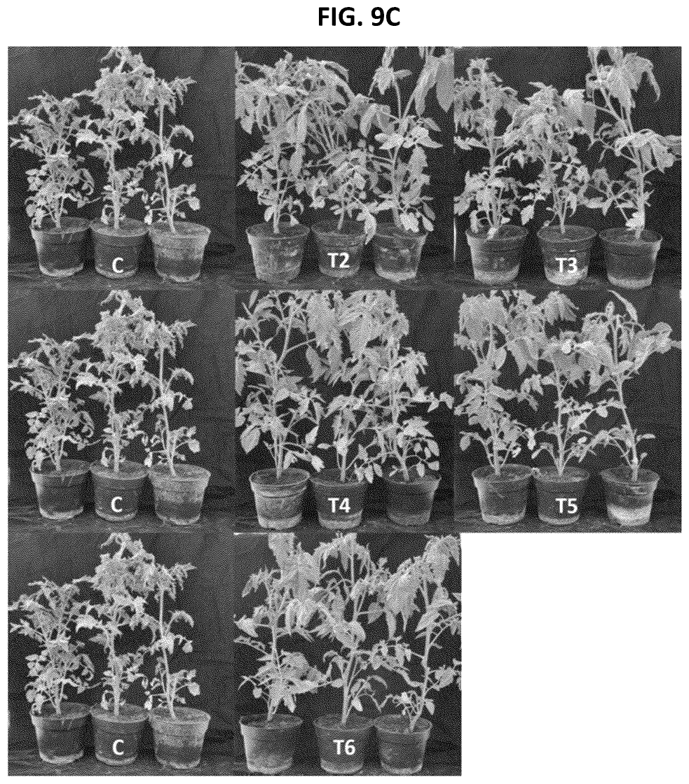

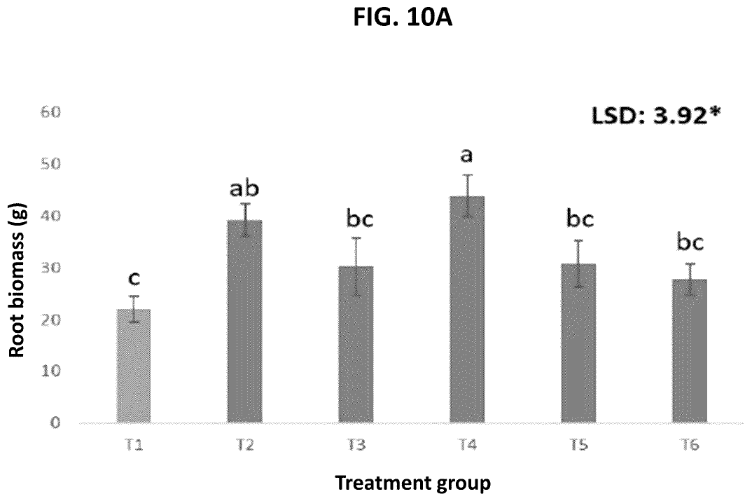

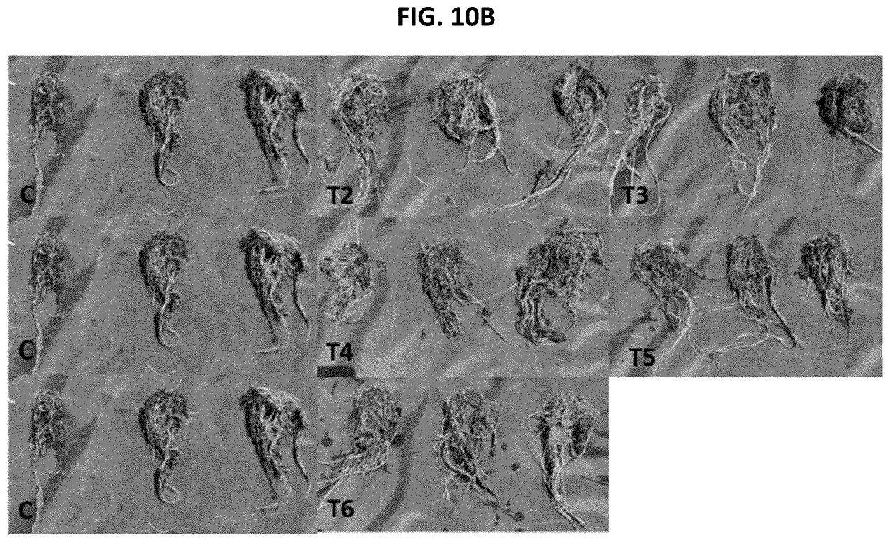

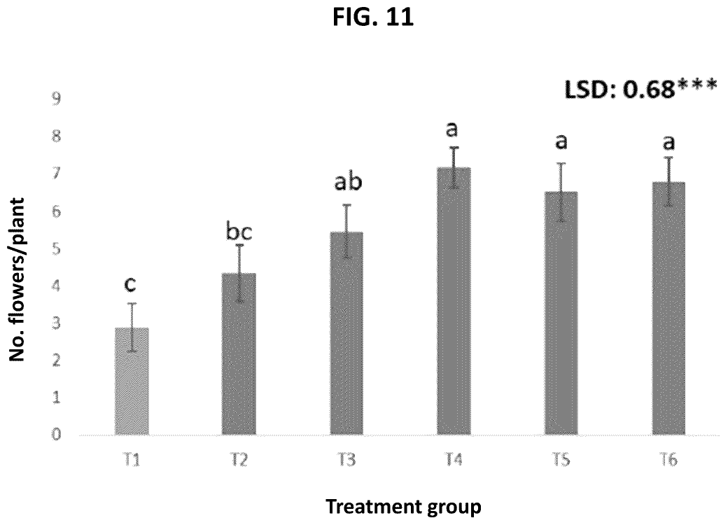

Sampling 1—Tomato. Treatments T2-T6 all demonstrated an increase in aerial biomass relative to control, up to 60% greater than T1, indicating a significant improvement in early growth among all treatment conditions compared to control. FIG. 9A-9C show the graph of results, photos of individual plants in each treatment condition assessed in the first sampling, and photos of the group of plants in each treatment condition assessed in the first sampling. Root biomass was also higher in all treatments compared to control, with condition T4 demonstrating over 100% greater root biomass than control. See FIG. 10A-10B. All treatment conditions improved early flowering compared to control, with T4-T6 exhibiting more than double the number of flowers/plant compared to control. See FIG. 11.

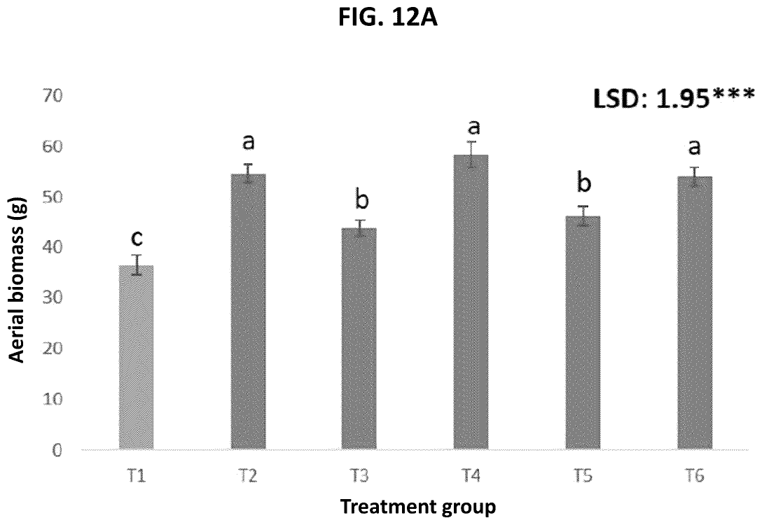

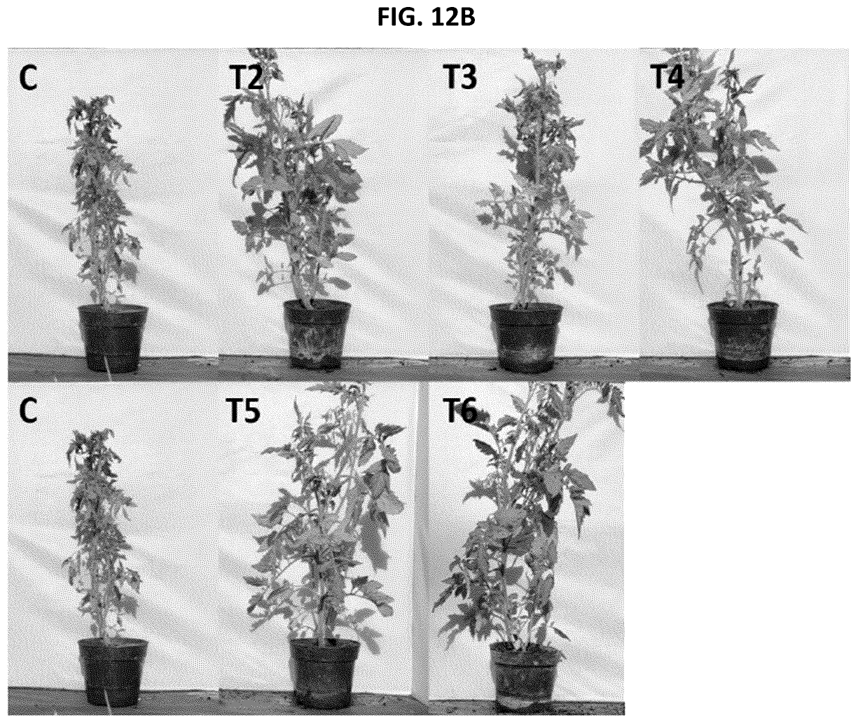

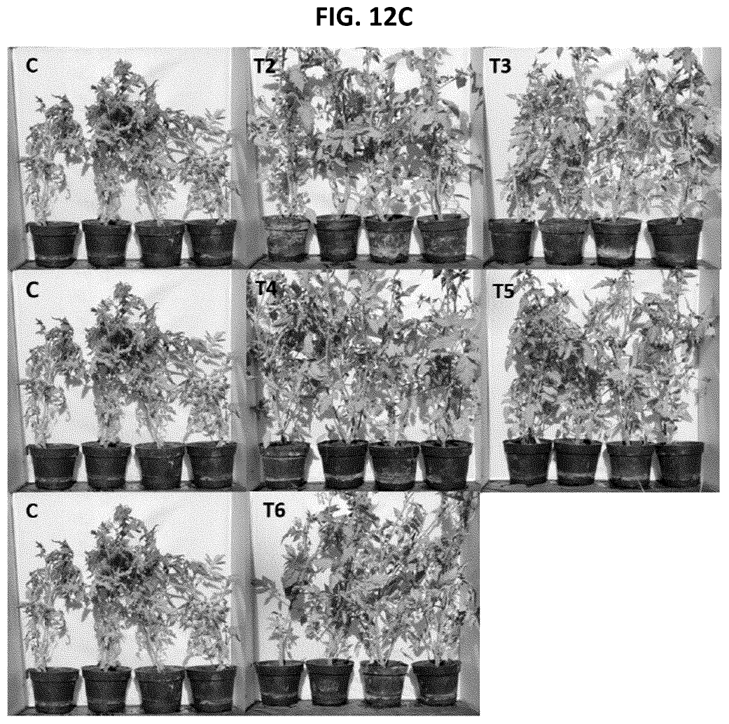

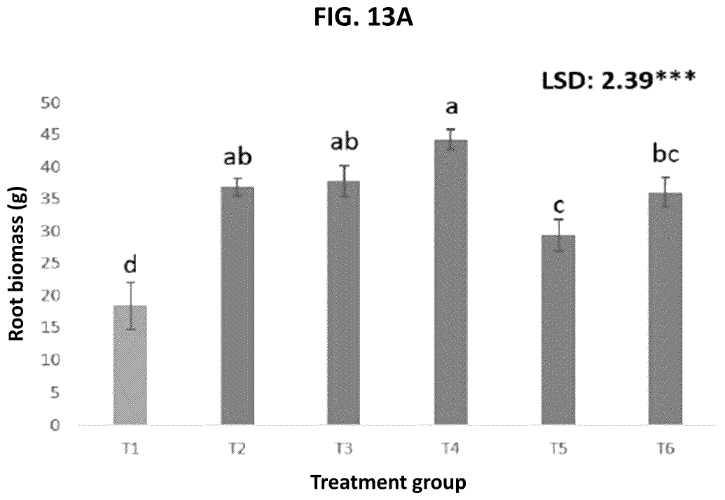

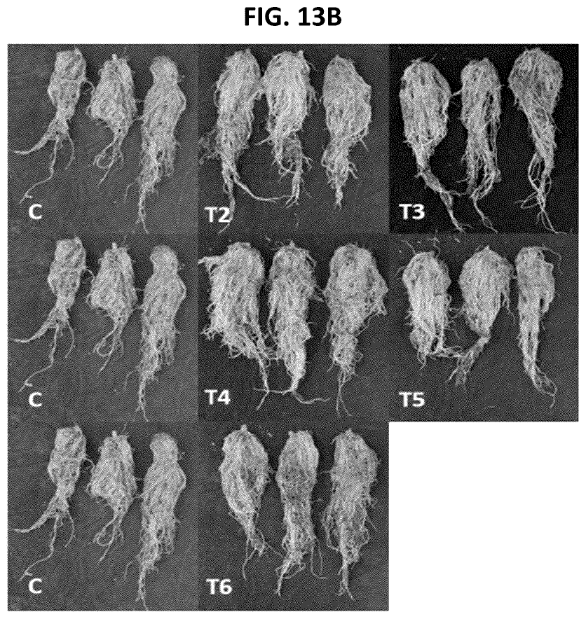

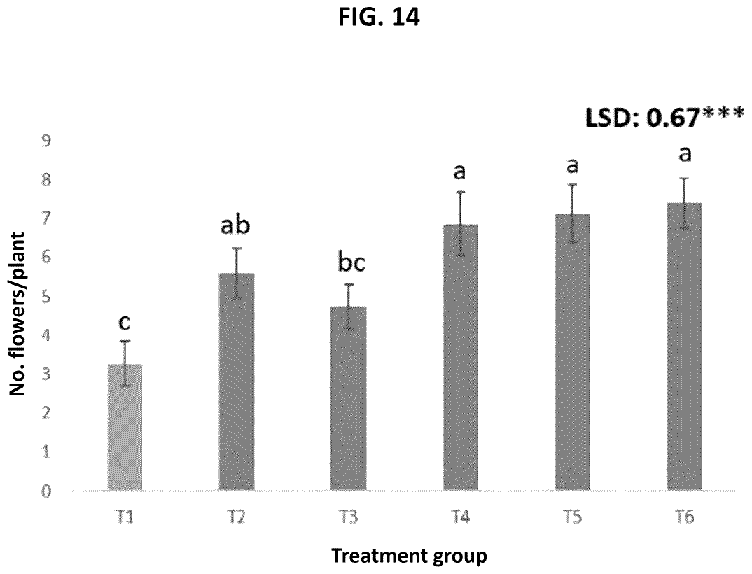

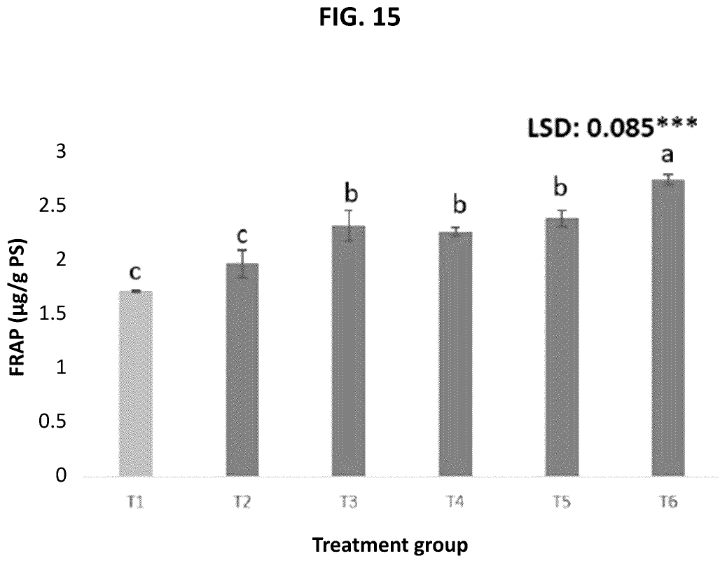

Sampling 2—Tomato. In the second sampling, all treatment conditions exhibited greater aerial biomass, root biomass, number of fruits, number of flowers/plant, and antioxidant capacity than control. Aerial and root biomass were highest in the combination condition T4, which outperformed either of the components individually administered (i.e., T2 and T3). See aerial biomass results in FIGS. 12A-12C and root biomass results in FIGS. 13A-13B. In addition, the number of flowers/plant, which is a correlate for eventual yield, was highest for all three combination treatments, T4-T6. See FIG. 14. All treatment groups showed some fruit, while the control did not show fruit. The analysis of photosynthetic pigments did not reveal statistically significant differences among the groups. However, T4 had the highest numerical concentrations of chlorophyl A, chlorophyl B, and carotenoids, exceeding the values for the control by 10-20%. Differences in soluble protein content were not significant. The antioxidant response was higher for all treatment conditions. See FIG. 15. Surprisingly, the 40%/60% combination condition represented in T6 produced the highest antioxidant response in the plant.

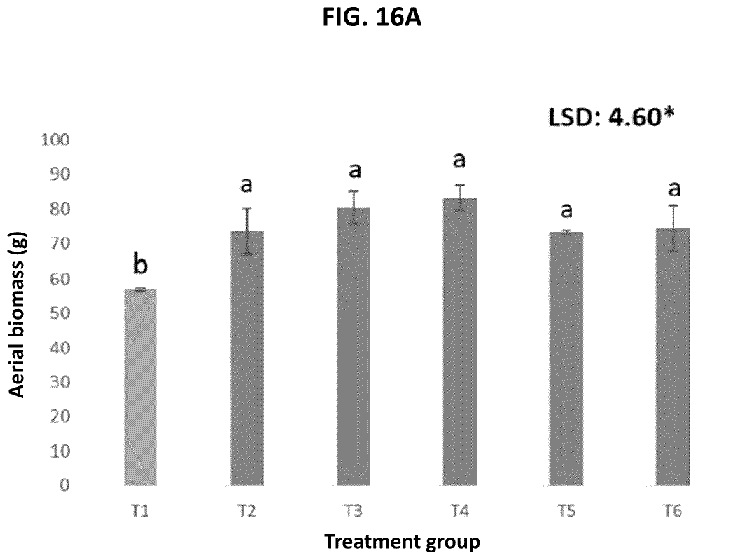

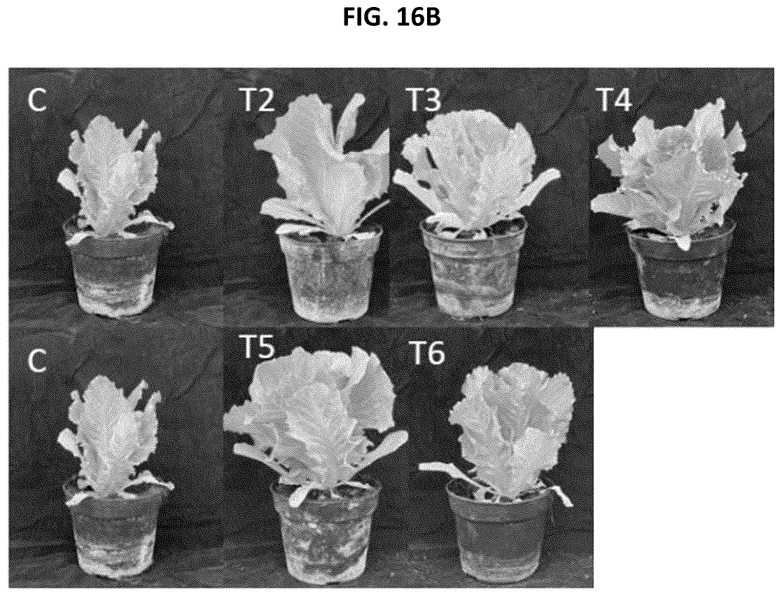

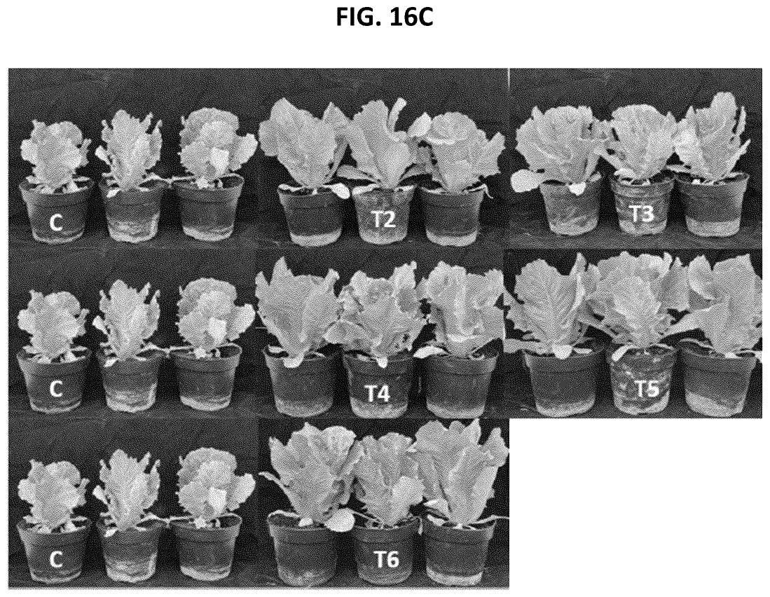

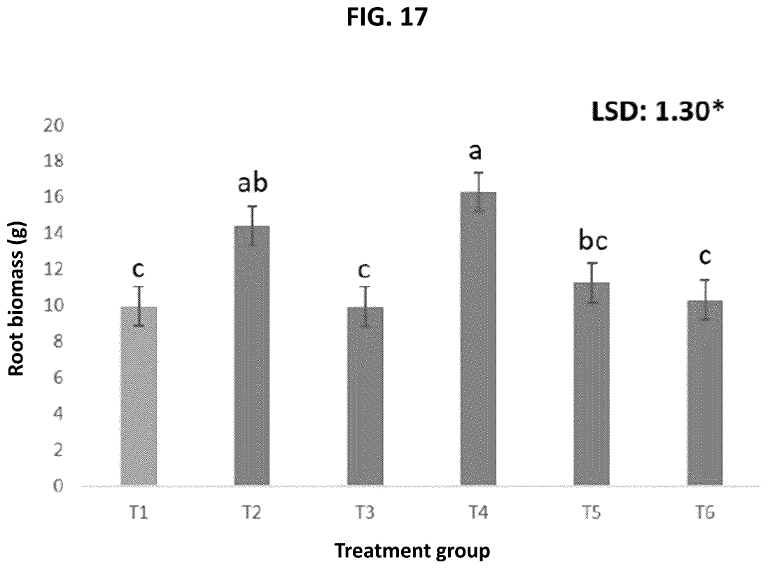

Sampling 1—Lettuce. In the first sampling, all treatment conditions outperformed control for aerial biomass (FIGS. 16A-16C). Root biomass was on par with or higher than control for all treatment conditions (FIG. 17). In particular, the combination composition in T4 resulted in more than 50% higher root biomass than the control.

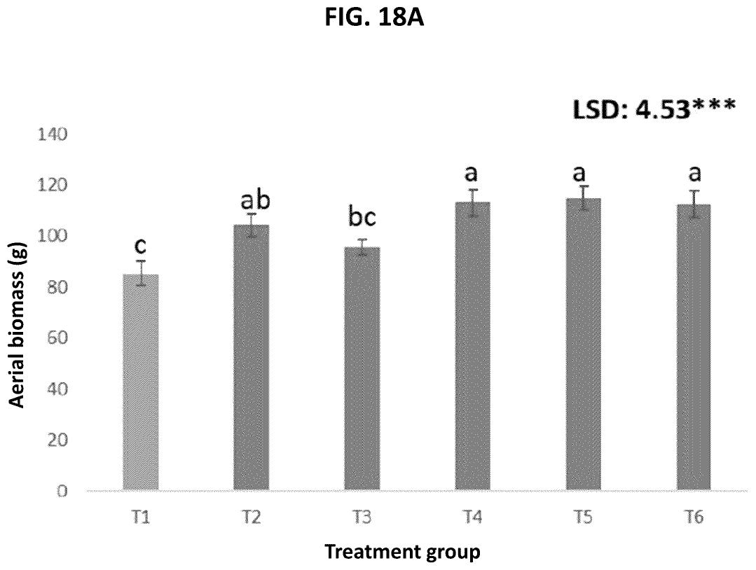

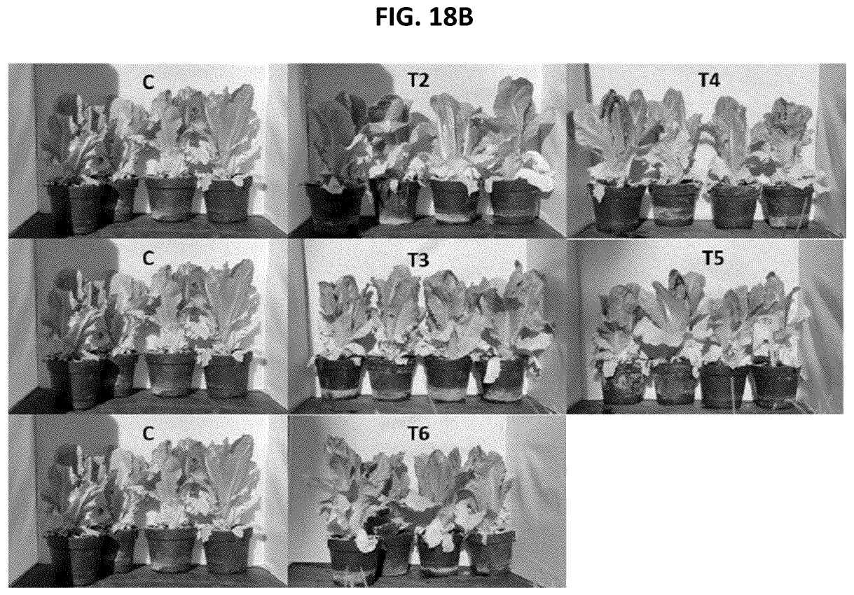

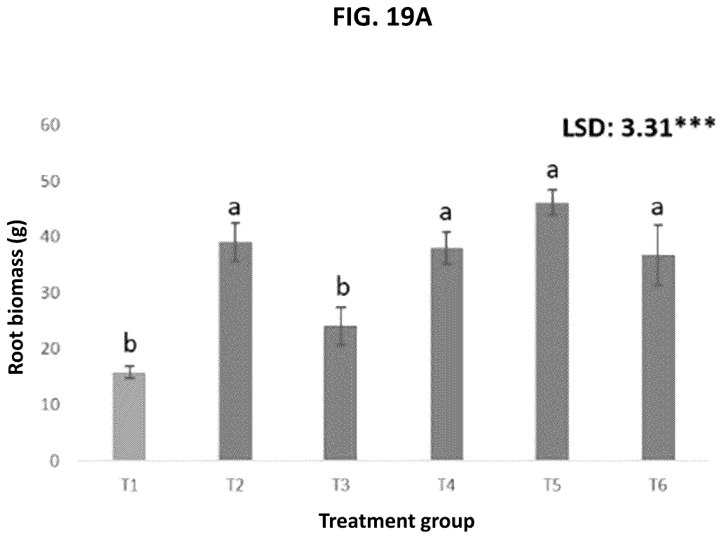

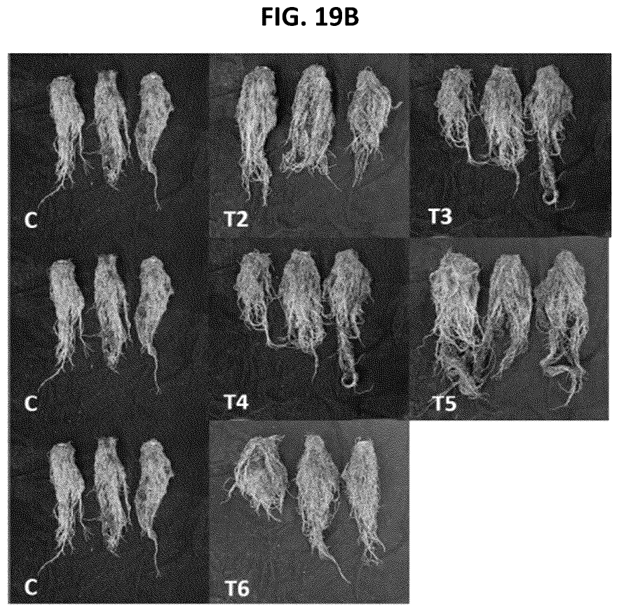

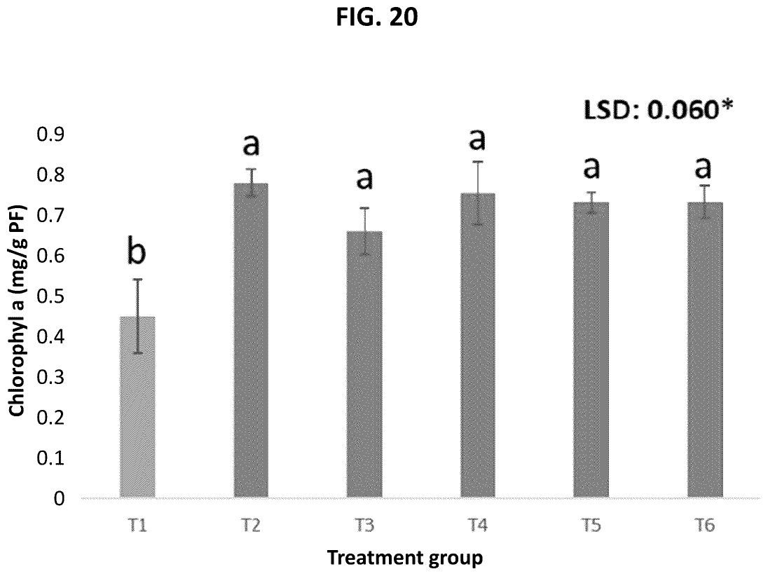

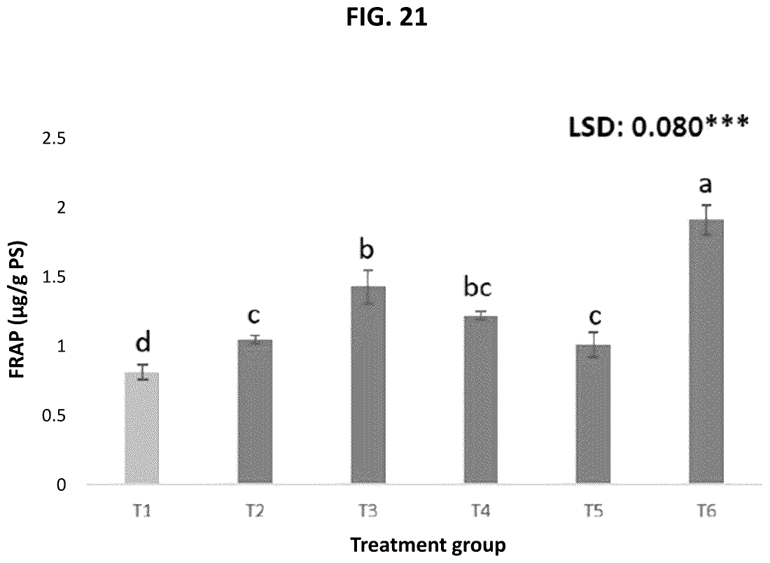

Sampling 2—Lettuce. In the second sampling, all treatment conditions outperformed control for aerial biomass (FIGS. 18A-18B) and root biomass (FIGS. 19A-19B). In terms of aerial biomass, all three combination compositions performed best. In terms of root biomass, treatments T2, T4, T5, and T6 were on par. Differences in pigment and soluble protein were not significant, except for chlorophyl A (FIG. 20), which was higher in all treatment conditions than in the control. Antioxidant response was higher in all treatment conditions than in control. Surprisingly, the 40%/60% combination condition represented in T6 produced the highest antioxidant response in the plant.

The results in lettuce and tomato demonstrate an improvement in early growth, plant biomass, and expected yield in both plant types for all combinations of DMS and CFS tested.

### Example 7: Application of Illustrative DMS/Myco/CFS Granules of the Disclosure in a Field Trial in Paddy Rice

### Materials & Methods

Bentonite granules were formulated comprising 2.5% DMS and 2% Myco or comprising 1.25% DMS, 1.25% CFS, and 2% Myco. Both of these granules were compared to control (no granule application) in a field trial in paddy rice. Granules were applied in a single application at a rate of 10 kg/ha to the soil.

The different treatment conditions were measured for differences in yield, number of tillers, panicle length, test weight, and overall appearance.

### Results

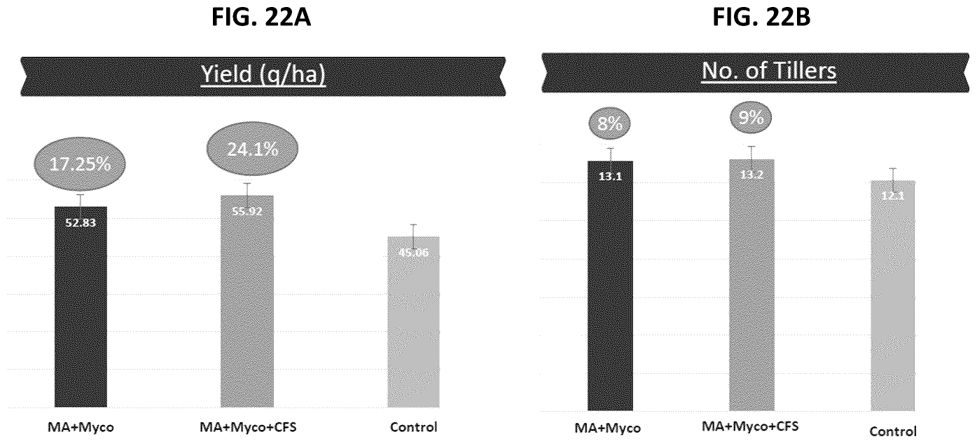

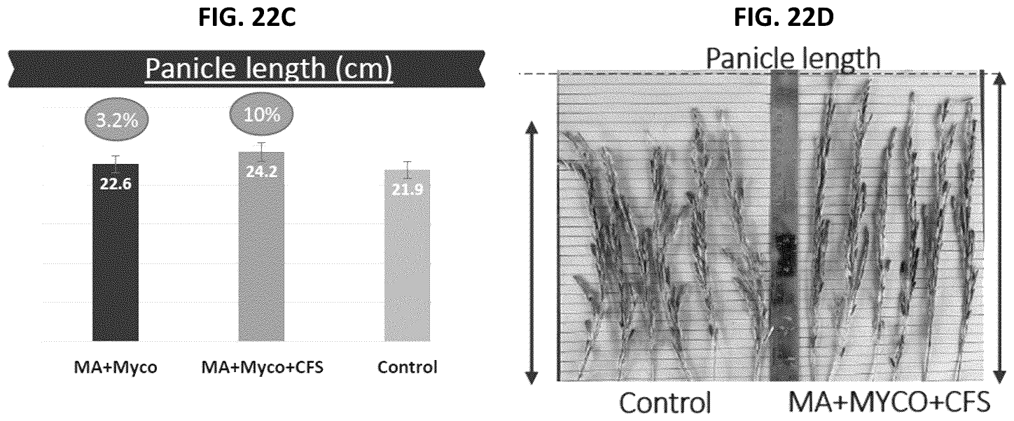

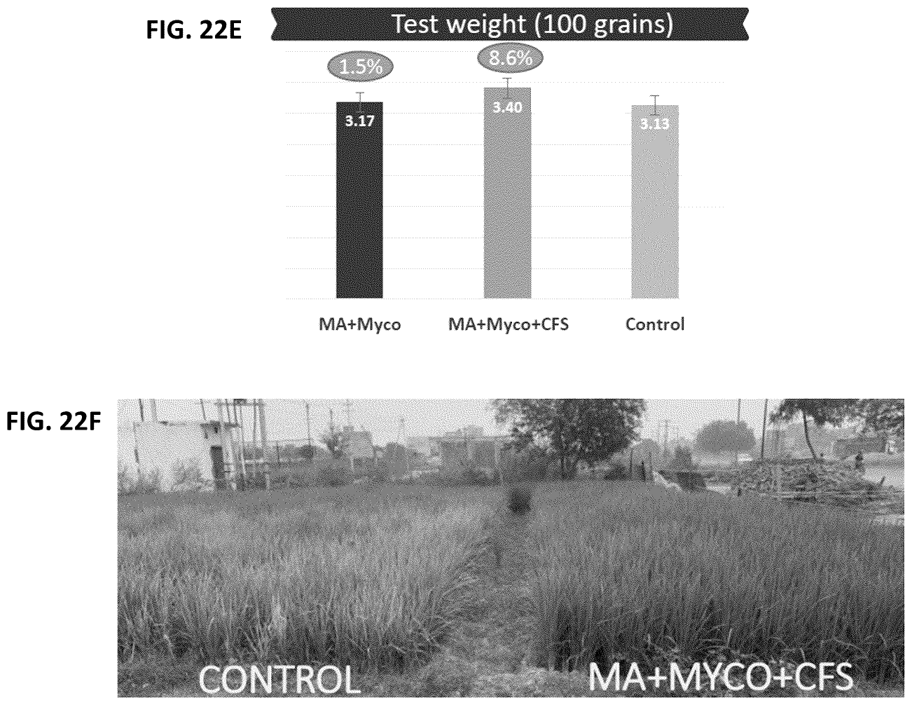

Yield. Both granule treated conditions significantly outperformed control. The triple combination granules resulted in a 24.10% increase in yield, while the DMS/Myco combination resulted in a 17.25% increase in yield. See FIG. 22A.

Number of tillers. Both treated conditions outperformed control in terms of number of rice tillers. The triple combination yielded a 9% increase in tillers, as opposed to an 8% increase in the DMS/Myco granule condition. See FIG. 22B.

Panicle length. Panicle length was measured in all three conditions. The results were significantly higher for the triple combination DMS/CFS/Myco granules, yielding a 10% increase in panicle length compared to control. The DMS/Myco combination yielded a 3.2% increase in panicle length. See results in FIG. 22C and an image of example panicles from the control and triple combination conditions in FIG. 22D.

Test weight. Test weight was measured for 100 grains. DMS/CFS/Myco treatment yielded an 8.6% increase in test weight; and DMS/Myco treatment yielded a 1.5% increase.

### See FIG. 22E.

Appearance. The visual appearance of rice was compared between control and DMS/CFS/Myco granule treated crops. The rice crops in the treated condition were visually healthier, greener, and fuller in appearance than control crops. See FIG. 22F.

These results demonstrate that application of a DMS/CFS/Myco combination composition to paddy rice significantly improved multiple growth, production, and biostimulant parameters of the paddy rice.

### Example 8: Application of Illustrative DMS/Myco/CFS Granules of the Disclosure in a Field Trial in Chili Peppers

Materials & Methods

Bentonite granules were formulated comprising 2.5% DMS and 2% Myco or comprising 1.25% DMS, 1.25% CFS, and 2% Myco. Both of these granules were compared to control (no granule application) and a commercially available agricultural product (EcoMax®) in a field trial in paddy rice. Granules were applied in a single application at a rate of 4 kg/ha for the DMS/Myco granules; 4 kg/ha for the DMS/CFS/Myco granules; and 2 kg/ha for the EcoMax® commercially available product.

The different treatment conditions were measured for differences in yield and number of shriveled fruit.

### Results

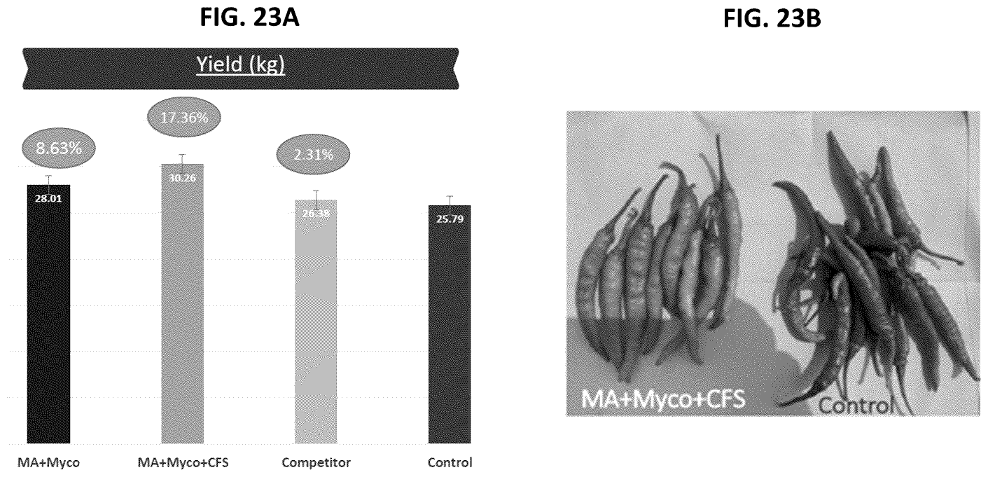

Yield. All treated conditions outperformed control. Application of the triple combination composition DMS/CFS/Myco granules resulted in the highest yield, 17.36% higher than control, while the DMS/Myco granules resulted in a 8.63% increase. Both significantly outperformed the commercial standard, which resulted in only a 2.31% increase in yield. See FIG. 23A.

Number of shriveled fruit. A visual comparison of the fruit picked from this trial yielded the observation of many fewer shriveled fruit in the DMS/Myco and DMS/CFS/Myco treated conditions. FIG. 23B shows an exemplary image demonstrating healthy fruit from the DMS/CFS/Myco treated condition and shriveled fruit from the Control condition.

These results demonstrate that application of a DMS/CFS/Myco combination composition to chili peppers significantly improved yield and decreased shriveled fruit.

### Example 9: Application of Illustrative DMS/Myco Liquid Composition of the Disclosure in a Field Trial in Tomato Plants

### Materials & Methods

A combination composition comprising DMS, CFS, and biofulvic acids was formulated and compared to control (no application), a commercially available agricultural product, and a combination of DMS and Azospirillum nitrogen-fixing bacteria. All tested compositions were applied at a rate of 1.25 L/ha as a foliar spray.

The different treatment conditions were measured for differences in yield and amount of discarded fruit.

### Results

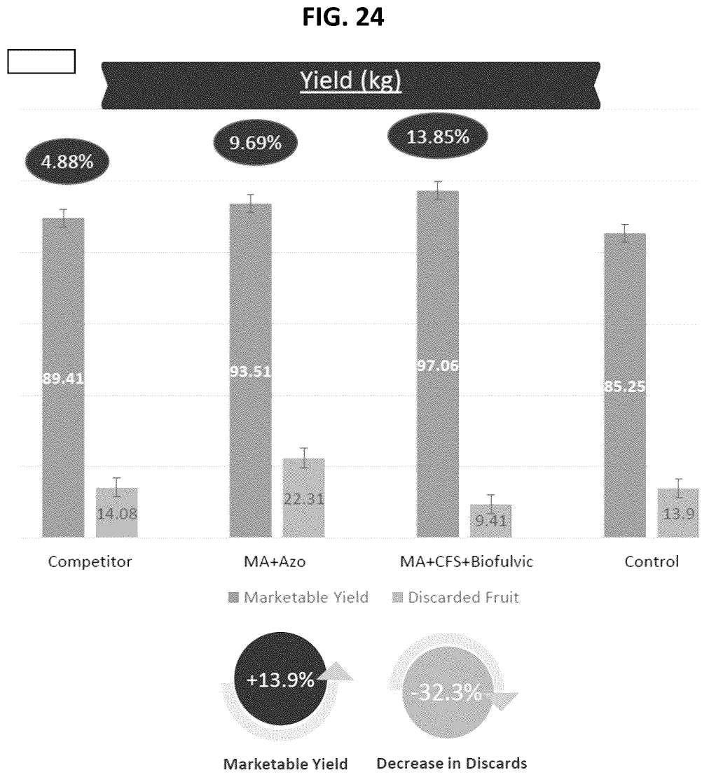

Yield. The DMS/CFS combination composition with biofulvic acid resulted in the highest yield of all tested products, 13.85% higher than control. See FIG. 24.

Amount of discarded fruit. The DMS/CFS combination composition with biofulvic acid resulted in the lowest yield of discarded fruit, 32.3% lower than control. See FIG. 24.

These results demonstrate that application of a DMS/CFS combination composition to tomatoes resulted in a marked increase in yield and decrease in discarded fruit.

### Example 10: Application of Illustrative DMS/Myco Liquid Composition of the Disclosure in a Field Trial in Rice

### Materials & Methods

A combination composition comprising DMS, CFS, and biofulvic acids was formulated and compared to control (no application), and a combination of DMS and Azospirillum nitrogen-fixing bacteria. All tested compositions were applied at a rate of 1.25 L/ha as a root drench.

The different treatment conditions were measured for differences in yield and number of chaffy (empty) grains.

### Results

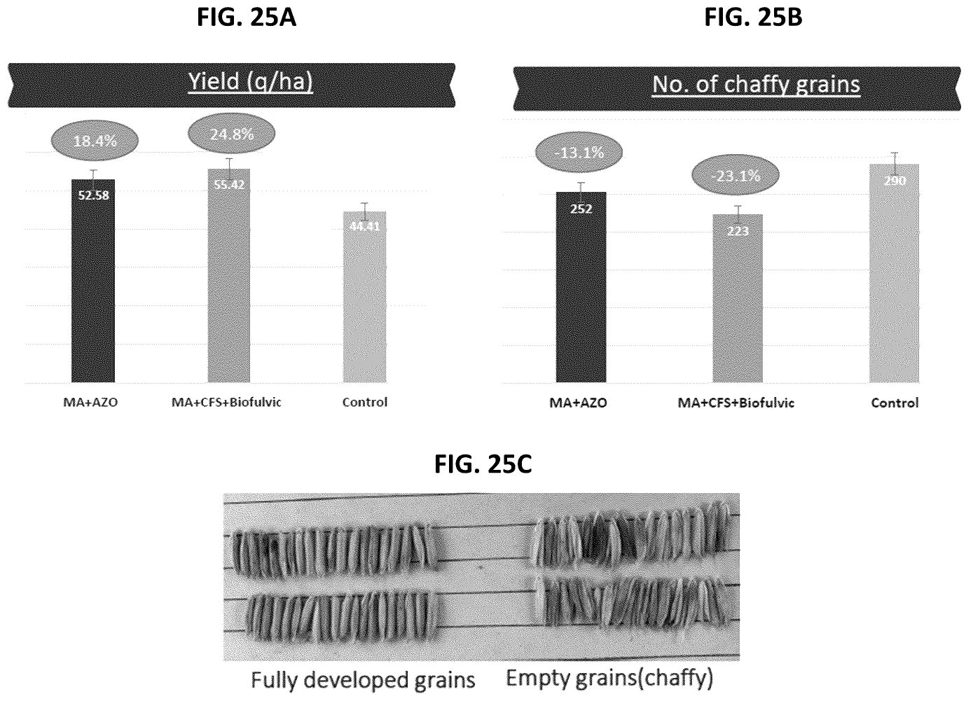

Yield. Both treated conditions outperformed control. Yield was significantly higher for the DMS/CFS/biofulvic acid treated condition (24.8%) than for the DMS/Azo condition (18.4%) or control. See FIG. 25A.

Number of empty grains. Both treated conditions outperformed control. The number of chaffy grains was significantly lower for the DMS/CFS/biofulvic acid treated condition (−23.1%) than for the DMS/Azo condition (−13.1%) or control. See FIG. 25B. FIG. 25C shows an image depicting fully developed grains versus empty chaffy grains.

These results demonstrate the remarkable effect of an illustrative application of a DMS/CFS composition of the disclosure to rice for improving yield and decreasing number of empty grains.

### INCORPORATION BY REFERENCE

All references, articles, publications, patents, patent publications, and patent applications cited herein are incorporated by reference in their entireties for all purposes. However, mention of any reference, article, publication, patent, patent publication, and patent application cited herein is not, and should not be taken as an acknowledgment or any form of suggestion that they constitute valid prior art or form part of the common general knowledge in any country in the world.

### NUMBERED EMBODIMENTS OF THE INVENTION

Notwithstanding the appended claims, the disclosure sets forth the following numbered embodiments:
1. An agricultural composition comprising:
   a) microalgae; and
   b) a cell free supernatant (“CFS”) of a microbial culture.
2. An agricultural composition comprising:
   a) a cell free supernatant (“CFS”) of a microbial culture; and
   b) mycorrhizae.
3. An agricultural composition comprising:
   a) microalgae;
   b) a cell free supernatant (“CFS”) of a microbial culture; and
   c) mycorrhizae.
4. The composition of any one of embodiments 1-3, wherein the composition comprises multiple species of microalgae.
5. The composition of any one of embodiments 1-4, wherein the composition comprises microalgae from a phylum selected from the list consisting of: Chlorophyta, Cryptophyta, Cyanophyta, Euglenophyta, Heterokontophyta, or Rhodophyta.
6. The composition of any one of embodiments 1-5, wherein the composition comprises microalgae from a genus selected from the list consisting of: Chlorella, Scenedesmus, Nannochloropsis, Muriellopsis, Isochrysis, Tisochrysis, Desmodesmus, Haematococcus, Arthrospira, and Anabaena.
7. The composition of any one of embodiments 1-6, wherein the microalgae are dried, lysed, and/or digested.
8. The composition of any one of embodiments 1-7, wherein the composition comprises microalgae in the form of a digested microalgae solution (“DMS”) or whole-cell microalgae powder.
9. The composition of any one of embodiments 1-8, wherein the composition comprises about 0.8-20 g/L of whole-cell microalgae powder.
10. The composition of any one of embodiments 1-9, wherein the composition comprises microalgae in the form of DMS, and wherein the composition comprises about 0.05-0.5% v/v DMS.
11. The composition of any one of embodiments 1-10, wherein the composition comprises about 0.005-0.05% w/w microalgae dry matter.
12. The composition of any one of embodiments 1-11, wherein the composition comprises microalgae in the form of DMS, and wherein the ratio of DMS to CFS is between 1:4 and 4:1.
13. The composition of any one of embodiments 1-12, wherein the composition comprises microalgae in the form of DMS, wherein the ratio of DMS to CFS is between 1:4 and 4:1, and wherein the composition comprises the combination of DMS and CFS diluted to 0.3-0.5% v/v in water.
14. The composition of any one of embodiments 1-13, wherein the composition comprises microalgae in the form of DMS, and wherein the ratio of DMS to CFS is 1:4 or 2:3.
15. The composition of any one of embodiments 1-14, wherein the composition comprises about 0.5-5.0% w/w of DMS.
16. The composition of any one of embodiments 1-15, wherein the composition comprises about 0.05-0.5% w/w of microalgae dry matter.
17. The composition of any one of embodiments 1-16, wherein the CFS is the isolated CFS of a mixed microbial culture comprising one or more microorganisms selected from the list consisting of: Aspergillus spp., Bacillus spp., Rhodopseudomonas spp., Candida spp., Lactobacillus spp., Lactococcus spp., Pseudomonas spp., Saccharomyces spp., Streptococcus spp., and combinations thereof.
18. The composition of any one of embodiments 1-17, wherein the CFS is the isolated CFS of a mixed microbial culture obtained from culturing IN-M1, deposited under ATCC Accession No. PTA-12383, or IN-M2, deposited under ATCC Accession No. PTA-121556.
19. The composition of any one of embodiments 1-18, wherein the CFS comprises at least 2500 micrograms potassium per gram, at least 435 micrograms nitrogen per gram, at least 475 micrograms calcium per gram, and/or at least 200 micrograms magnesium per gram.
20. The composition of any one of embodiments 1-19, wherein the CFS comprises a CFS of a mixed microbial culture that has been diluted between 1:50 and 1:2000 with water.
21. The composition of any one of embodiments 1-20, wherein the CFS comprises about 2% dry matter.
22. The composition of any one of embodiments 1-21, wherein the composition comprises about 0.005-0.05% w/w CFS dry matter.
23. The composition of any one of embodiments 1-22, wherein the composition comprises about 0.5-5.0% w/w CFS.
24. The composition of any one of embodiments 1-23, wherein the mycorrhizae comprise a combination of ectomycorrhizae and endomycorrhizae.
25. The composition of any one of embodiments 1-24, wherein the mycorrhizae comprise predominantly endomycorrhizae.
26. The composition of any one of embodiments 1-25, wherein the mycorrhizae comprise more than about 90% endomycorrhizae.
27. The composition of any one of embodiments 1-26, wherein the composition comprises about 0.5-5.0% mycorrhizae.
28. The composition of any one of embodiments 1-27, wherein the mycorrhizae comprise 100-10,000 spores/gram.
29. The composition of any one of embodiments 1-28, wherein the composition comprises 500-500,000 spores of mycorrhizae per kg of composition.
30. The composition of any one of embodiments 1-29, wherein the composition comprises a diazotrophic bacterium.
31. The composition of any one of embodiments 1-30, wherein the composition comprises a symbiotic diazotrophic bacterium.
32. The composition of any one of embodiments 1-31, wherein the composition comprises a bacterium of a genus selected from the list consisting of: Anabaena, Azoarcus, Azorhizobium, Azospirillum, Azotobacter, Bacillus, Bradyrhizobium, Burkholderia, Clostridium, Frankia, Gluconacetobacter, Herbaspirillum, Klebsiella, Mesorhizobium, Nitrosospira, Nostoc, Paenibacillus, Parasponia, Pseudomonas, Rhizobium, Rhodobacter, Sinorhizobium, Spirillum, or Xanthomonus.
33. The composition of any one of embodiments 1-32, wherein the composition comprises a bacterium of the genus Azospirillum, Bradyrhizobium, or Rhizobium.
34. The composition of any one of embodiments 1-33, wherein the composition is applied to an agricultural crop.
35. The composition of any one of embodiments 1-34, wherein the composition is applied to an agricultural crop, wherein the agricultural crop is a monocot or dicot.
36. The composition of any one of embodiments 1-35, wherein the composition is applied to an agricultural crop selected from the list consisting of agronomical crops, horticultural crops, and ornamental crops.
37. The composition of any one of embodiments 1-36, wherein application of the composition to an agricultural crop results in an increase in a growth, production, or biostimulant parameter of the agricultural crop in comparison to a control agricultural crop without the composition.
38. The composition of any one of embodiments 1-37, wherein application of the composition to an agricultural crop results in an increase in a growth, production, or biostimulant parameter of the agricultural crop in comparison to a control agricultural crop without the composition, wherein the parameter is selected from the group consisting of: biomass, aerial biomass, number of roots, root biomass, number of secondary roots, uniformity of flowering, number of flowers, yield, number of fruits, productivity, chlorophyl content, carotenoid profile, antioxidant response capacity, water absorption capacity, nutrient absorption, and degree of inoculation by diazotrophic bacteria.
39. The composition of any one of embodiments 1-38, wherein the combination of the contents of the composition produces a synergistic improvement on a growth, production, or biostimulant parameter of an agricultural crop after application.
40. The composition of any one of embodiments 1-39, wherein the combination of the contents of the composition produces an improvement on a growth, production, or biostimulant parameter of an agricultural crop after application thereto, wherein the improvement is greater than that observed for any component alone.
41. The composition of any one of embodiments 1-40, wherein the composition comprises a carrier.
42. The composition of any one of embodiments 1-41, wherein the composition comprises a liquid carrier.
43. The composition of any one of embodiments 1-42, wherein the composition comprises a liquid carrier, and the liquid carrier is water.
44. The composition of any one of embodiments 1-43, wherein the composition comprises a solid carrier.
45. The composition of any one of embodiments 1-44, wherein the composition comprises a solid carrier, and wherein the carrier makes up more than 80% of the composition.
46. The composition of any one of embodiments 1-45, wherein the composition comprises a carrier, and wherein the carrier is a natural clay-based or mineral-based carrier.
47. The composition of any one of embodiments 1-46, wherein the composition comprises a carrier selected from the group consisting of clay, zeolite, dolomite, bentonite, leonardite, and attapulgite.
48. A method for increasing the yield of an agricultural crop, the method comprising:
   a) applying the composition of any one of embodiments 1-47 to the agricultural crop.
49. A method for increasing the yield of an agricultural crop, the method comprising:
   a) applying an agricultural composition to the agricultural crop, the composition comprising i) a cell free supernatant (“CFS”) of a microbial culture; and ii) microalgae and/or mycorrhizae.
50. A method for improving a production, growth, or biostimulant parameter of an agricultural crop, the method comprising:
   a) applying an agricultural composition to the agricultural crop, the composition comprising i) a cell free supernatant (“CFS”) of a microbial culture; and ii) microalgae and/or mycorrhizae.
51. The method of any one of embodiments 48-50, wherein the composition comprises multiple species of microalgae.
52. The method of any one of embodiments 48-51, wherein the composition comprises microalgae from a phylum selected from the list consisting of: Chlorophyta, Cryptophyta, Cyanophyta, Euglenophyta, Heterokontophyta, or Rhodophyta.
53. The method of any one of embodiments 48-52, wherein the composition comprises microalgae from a genus selected from the list consisting of: Chlorella, Scenedesmus, Nannochloropsis, Muriellopsis, Isochrysis, Tisochrysis, Desmodesmus, Haematococcus, Arthrospira, and Anabaena.
54. The method of any one of embodiments 48-53, wherein the microalgae are dried and/or lysed.
55. The method of any one of embodiments 48-54, wherein the composition comprises microalgae in the form of a digested microalgae solution (“DMS”) or whole-cell microalgae powder.
56. The method of any one of embodiments 48-55, wherein the composition comprises about 0.8-20 g/L of whole-cell microalgae powder.
57. The method of any one of embodiments 48-56, wherein the composition comprises microalgae in the form of DMS, and wherein the composition comprises about 0.05-0.5% v/v DMS.
58. The method of any one of embodiments 48-57, wherein the composition comprises about 0.005-0.05% w/w microalgae dry matter.
59. The method of any one of embodiments 48-58, wherein the composition comprises microalgae in the form of DMS, and wherein the ratio of DMS to CFS is between 1:4 and 4:1.
60. The method of any one of embodiments 48-59, wherein the composition comprises microalgae in the form of DMS, wherein the ratio of DMS to CFS is between 1:4 and 4:1, and wherein the composition comprises the combination of DMS and CFS diluted to 0.3-0.5% v/v in water.
61. The method of any one of embodiments 48-60, wherein the composition comprises microalgae in the form of DMS, and wherein the ratio of DMS to CFS is 1:4 or 2:3.
62. The method of any one of embodiments 48-61, wherein the composition comprises about 0.5-5.0% w/w of DMS.
63. The method of any one of embodiments 48-62, wherein the composition comprises about 0.05-0.5% w/w of microalgae dry matter.
64. The method of any one of embodiments 48-63, wherein the CFS is the isolated CFS of a mixed microbial culture comprising one or more microorganisms selected from the list consisting of: Aspergillus spp., Bacillus spp., Rhodopseudomonas spp., Candida spp., Lactobacillus spp., Lactococcus spp., Pseudomonas spp., Saccharomyces spp., Streptococcus spp., and combinations thereof.
65. The method of any one of embodiments 48-64, wherein the CFS is the isolated CFS of a mixed microbial culture obtained from culturing IN-M1, deposited under ATCC Accession No. PTA-12383, or IN-M2, deposited under ATCC Accession No. PTA-121556.
66. The method of any one of embodiments 48-65, wherein the CFS comprises at least 2500 micrograms potassium per gram, at least 435 micrograms nitrogen per gram, at least 475 micrograms calcium per gram, and/or at least 200 micrograms magnesium per gram.
67. The method of any one of embodiments 48-66, wherein the CFS comprises a CFS of a mixed microbial culture that has been diluted between 1:50 and 1:2000 with water.
68. The method of any one of embodiments 48-67, wherein the CFS comprises about 2% dry matter.
69. The method of any one of embodiments 48-68, wherein the composition comprises about 0.005-0.05% w/w CFS dry matter.
70. The method of any one of embodiments 48-69, wherein the composition comprises about 0.5-5.0% w/w CFS.
71. The method of any one of embodiments 48-70, wherein the mycorrhizae comprise a combination of ectomycorrhizae and endomycorrhizae.
72. The method of any one of embodiments 48-71, wherein the mycorrhizae comprise predominantly endomycorrhizae.
73. The method of any one of embodiments 48-72, wherein the mycorrhizae comprise more than about 90% endomycorrhizae.
74. The method of any one of embodiments 48-73, wherein the composition comprises about 0.5-5.0% mycorrhizae.
75. The method of any one of embodiments 48-74, wherein the mycorrhizae comprise 100-10,000 spores/gram.
76. The method of any one of embodiments 48-75, wherein the composition comprises 500-500,000 spores of mycorrhizae per kg of composition.
77. The method of any one of embodiments 48-76, wherein the composition comprises a diazotrophic bacterium.
78. The method of any one of embodiments 48-77, wherein the composition comprises a symbiotic diazotrophic bacterium.
79. The method of any one of embodiments 48-78, wherein the composition comprises a bacterium of a genus selected from the list consisting of: Anabaena, Azoarcus, Azorhizobium, Azospirillum, Azotobacter, Bacillus, Bradyrhizobium, Burkholderia, Clostridium, Frankia, Gluconacetobacter, Herbaspirillum, Klebsiella, Mesorhizobium, Nitrosospira, Nostoc, Paenibacillus, Parasponia, Pseudomonas, Rhizobium, Rhodobacter, Sinorhizobium, Spirillum, and Xanthomonus.
80. The method of any one of embodiments 48-79, wherein the composition comprises a bacterium of the genus Azospirillum, Bradyrhizobium, or Rhizobium.
81. The method of any one of embodiments 48-80, wherein the agricultural crop is a monocot or dicot.
82. The method of any one of embodiments 48-81, wherein the agricultural crop is selected from the list consisting of agronomical crops, horticultural crops, and ornamental crops.
83. The method of any one of embodiments 48-82, wherein the method results in an increase in a growth, production, or biostimulant parameter of the agricultural crop in comparison to a control agricultural crop without the composition.
84. The method of any one of embodiments 48-83, wherein the method results in an increase in a growth, production, or biostimulant parameter of the agricultural crop in comparison to a control agricultural crop without the composition, wherein the parameter is selected from the group consisting of: biomass, aerial biomass, number of roots, root biomass, number of secondary roots, uniformity of flowering, number of flowers, yield, number of fruits, productivity, chlorophyl content, carotenoid profile, antioxidant response capacity, water absorption capacity, nutrient absorption, and degree of inoculation by diazotrophic bacteria.
85. The method of any one of embodiments 48-84, wherein the combination of the contents of the composition produces a synergistic improvement on a growth, production, or biostimulant parameter of the agricultural crop.
86. The method of any one of embodiments 48-85, wherein the combination of the contents of the composition produces an improvement on a growth, production, or biostimulant parameter of the agricultural crop, and wherein the improvement is greater than that observed for any component alone.
87. The method of any one of embodiments 48-86, wherein the composition comprises a carrier.
88. The method of any one of embodiments 48-87, wherein the composition comprises a liquid carrier.
89. The method of any one of embodiments 48-88, wherein the composition comprises a liquid carrier, and the liquid carrier is water.
90. The method of any one of embodiments 48-89, wherein the composition comprises a solid carrier.
91. The method of any one of embodiments 48-90, wherein the composition comprises a solid carrier, and wherein the carrier makes up more than 80% of the composition.
92. The method of any one of embodiments 48-91, wherein the composition comprises a carrier, and wherein the carrier is a natural clay-based or mineral-based carrier.
93. The method of any one of embodiments 48-92, wherein the composition comprises a carrier selected from the group consisting of clay, zeolite, dolomite, bentonite, leonardite, and attapulgite.
94. The method of any one of embodiments 48-93, wherein the composition is applied to plant parts of the agricultural crop.
95. The method of any one of embodiments 48-94, wherein the composition is applied to plant parts of the agricultural crop, and wherein the plant parts are the seeds, seedlings, plant tissues, leaves, branches, stems, bulbs, tubers, roots, root hairs, rhizomes, cuttings, flowers, or fruits.
96. The method of any one of embodiments 48-95, wherein the composition is a liquid and is applied as a spray to the aerial biomass of the plant and/or as a soil treatment.
97. The method of any one of embodiments 48-96, wherein the composition is a liquid, and wherein the method comprises applying 1-10 L of the composition per hectare of the agricultural crop.
98. The method of any one of embodiments 48-97, wherein the composition is a granule, and wherein the method comprises applying 5-15 kg of the composition per hectare of the agricultural crop.
99. The method of any one of embodiments 48-98, wherein the composition is a granule, and wherein the method comprises applying an amount of the composition sufficient to deliver 10,000 to 2,000,000 spores of mycorrhizae per hectare of the agricultural crop.
100. The method of any one of embodiments 48-99, wherein the method comprises applying the composition more than once.
101. The method of any one of embodiments 48-100, wherein the method comprises applying the composition at the time of planting.
102. The method of any one of embodiments 48-101, wherein the method comprises applying the composition pre-blooming and/or within thirty days of planting, sowing, or tillering.

1. An agricultural composition comprising:
a) microalgae; and
b) a cell free supernatant (“CFS”) of a microbial culture.

2. An agricultural composition comprising:
a) a cell free supernatant (“CFS”) of a microbial culture; and
b) mycorrhizae.

3. An agricultural composition comprising:
a) microalgae;
b) a cell free supernatant (“CFS”) of a microbial culture; and
c) mycorrhizae.

4. The composition of claim 1 or 3, wherein the composition comprises multiple species of microalgae, optionally wherein:
a) the composition comprises microalgae from a phylum selected from the list consisting of: Chlorophyta, Cryptophyta, Cyanophyta, Euglenophyta, Heterokontophyta, or Rhodophyta; and/or
b) the composition comprises microalgae from a genus selected from the list consisting of: Chlorella, Scenedesmus, Nannochloropsis, Muriellopsis, Isochrysis, Tisochrysis, Desmodesmus, Haematococcus, Arthrospira, and Anabaena.

5. The composition of claim 1 or 3, wherein the microalgae are:
a) dried, lysed, and/or digested; and/or
b) in the form of a digested microalgae solution (“DMS”) or whole-cell microalgae powder.

6. The composition of claim 1, wherein the composition comprises:
a) about 0.8-20 g/L of whole-cell microalgae powder; and/or
b) about 0.05-0.5% v/v DMS.

7. The composition of claim 1, wherein the composition comprises about 0.005-0.05% w/w microalgae dry matter.

8. The composition of claim 1, wherein the composition comprises microalgae in the form of DMS, and wherein the ratio of DMS to CFS is between 1:4 and 4:1, optionally wherein the ratio of DMS to CFS is 1:4 or 2:3, optionally wherein the composition comprises the combination of DMS and CFS diluted to 0.3-0.5% v/v in water.

9. The composition of claim 3, wherein the composition comprises about 0.5-5.0% w/w of DMS and/or about 0.05-0.5% w/w of microalgae dry matter.

10. The composition of any one of claims 1-3, wherein the CFS comprises:
a) the isolated CFS of a mixed microbial culture comprising one or more microorganisms selected from the list consisting of: Aspergillus spp., Bacillus spp., Rhodopseudomonas spp., Candida spp., Lactobacillus spp., Lactococcus spp., Pseudomonas spp., Saccharomyces spp., Streptococcus spp., and combinations thereof;
b) the isolated CFS of a mixed microbial culture obtained from culturing IN-M1, deposited under ATCC Accession No. PTA-12383, or IN-M2, deposited under ATCC Accession No. PTA-121556;
c) at least 2500 micrograms potassium per gram, at least 435 micrograms nitrogen per gram, at least 475 micrograms calcium per gram, and/or at least 200 micrograms magnesium per gram;
d) a CFS of a mixed microbial culture that has been diluted between 1:50 and 1:2000 with water; and/or
e) about 2% dry matter.

11. The composition of claim 1, wherein the composition comprises about 0.005-0.05% w/w CFS dry matter.

12. The composition of claim 2 or 3, wherein the composition comprises about 0.5-5.0% w/w CFS.

13. The composition of claim 2 or 3, wherein the mycorrhizae comprise:
a) a combination of ectomycorrhizae and endomycorrhizae;
b) predominantly endomycorrhizae, optionally more than about 90% endomycorrhizae; and/or
c) 100-10,000 spores/gram.

14. The composition of claim 2 or 3, wherein the composition comprises about 0.5-5.0% mycorrhizae and/or 500-500,000 spores of mycorrhizae per kg of composition.

15. The composition of any one of claims 1-3, wherein the composition comprises a diazotrophic bacterium, optionally a symbiotic diazotrophic bacterium.

16. The composition of any one of claims 1-3, wherein the composition comprises a bacterium of a genus selected from the list consisting of: Anabaena, Azoarcus, Azorhizobium, Azospirillum, Azotobacter, Bacillus, Bradyrhizobium, Burkholderia, Clostridium, Frankia, Gluconacetobacter, Herbaspirillum, Klebsiella, Mesorhizobium, Nitrosospira, Nostoc, Paenibacillus, Parasponia, Pseudomonas, Rhizobium, Rhodobacter, Sinorhizobium, Spirillum, or Xanthomonus, optionally wherein the composition comprises a bacterium of the genus Azospirillum, Bradyrhizobium, or Rhizobium.

17. The composition of any one of claims 1-3, wherein the composition is applied to an agricultural crop, optionally wherein:
a) the agricultural crop is a monocot or dicot; and/or
b) the agricultural crop is selected from the list consisting of agronomical crops, horticultural crops, and ornamental crops.

18. The composition of any one of claims 1-3, wherein application of the composition to an agricultural crop results in an increase in a growth, production, or biostimulant parameter of the agricultural crop in comparison to a control agricultural crop without the composition, optionally wherein the parameter is selected from the group consisting of: biomass, aerial biomass, number of roots, root biomass, number of secondary roots, uniformity of flowering, number of flowers, yield, number of fruits, productivity, chlorophyl content, carotenoid profile, antioxidant response capacity, water absorption capacity, nutrient absorption, and degree of inoculation by diazotrophic bacteria.

19. The composition of any one of claims 1-3, wherein the combination of the contents of the composition produces an improvement on a growth, production, or biostimulant parameter of an agricultural crop after application thereto, optionally wherein the improvement is greater than that observed for any component alone.

20. The composition of any one of claims 1-3, wherein the composition comprises a carrier, optionally wherein:
a) the carrier is a liquid carrier, optionally wherein the liquid carrier is water;
b) the carrier is a solid carrier, optionally wherein the carrier makes up more than 80% of the composition.

21. The composition of claims 2 or 3, wherein the composition comprises a carrier, and wherein the carrier is a natural clay-based or mineral-based carrier, optionally wherein the carrier is selected from the group consisting of clay, zeolite, dolomite, bentonite, leonardite, and attapulgite.

22. A method for increasing the yield of an agricultural crop, the method comprising:
a) applying the composition of any one of claims 1-3 to the agricultural crop.

23. A method for increasing the yield of an agricultural crop, the method comprising:
a) applying an agricultural composition to the agricultural crop, the composition comprising i) a cell free supernatant (“CFS”) of a microbial culture; and ii) microalgae and/or mycorrhizae.

24. A method for improving a production, growth, or biostimulant parameter of an agricultural crop, the method comprising:
a) applying an agricultural composition to the agricultural crop, the composition comprising i) a cell free supernatant (“CFS”) of a microbial culture; and ii) microalgae and/or mycorrhizae.

25. The method of any one of claims 22-24, wherein the composition comprises multiple species of microalgae, optionally wherein:
a) the composition comprises microalgae from a phylum selected from the list consisting of: Chlorophyta, Cryptophyta, Cyanophyta, Euglenophyta, Heterokontophyta, or Rhodophyta.
b) the composition comprises microalgae from a genus selected from the list consisting of: Chlorella, Scenedesmus, Nannochloropsis, Muriellopsis, Isochrysis, Tisochrysis, Desmodesmus, Haematococcus, Arthrospira, and Anabaena.

26. The method of any one of claims 22-24, wherein the microalgae:
a) are dried and/or lysed; and/or
b) are in the form of a digested microalgae solution (“DMS”) or whole-cell microalgae powder.

27. The method of any one of claims 22-24, wherein the composition comprises:
a) about 0.8-20 g/L of whole-cell microalgae powder; and/or
b) about 0.05-0.5% v/v DMS.

28. The method of any one of claims 22-24, wherein the composition comprises about 0.005-0.05% w/w microalgae dry matter.

29. The method of any one of claims 22-24, wherein the composition comprises microalgae in the form of DMS, and wherein:
a) the ratio of DMS to CFS is between 1:4 and 4:1, optionally wherein the ratio of DMS to CFS is 1:4 or 2:3; and/or
b) the composition comprises the combination of DMS and CFS diluted to 0.3-0.5% v/v in water.

30. The method of any one of claims 22-24, wherein the composition comprises about 0.5-5.0% w/w of DMS and/or about 0.05-0.5% w/w of microalgae dry matter.

31. The method of any one of claims 22-24, wherein the CFS comprises:
a) the isolated CFS of a mixed microbial culture comprising one or more microorganisms selected from the list consisting of: Aspergillus spp., Bacillus spp., Rhodopseudomonas spp., Candida spp., Lactobacillus spp., Lactococcus spp., Pseudomonas spp., Saccharomyces spp., Streptococcus spp., and combinations thereof;
b) the isolated CFS of a mixed microbial culture obtained from culturing IN-M1, deposited under ATCC Accession No. PTA-12383, or IN-M2, deposited under ATCC Accession No. PTA-121556;
c) at least 2500 micrograms potassium per gram, at least 435 micrograms nitrogen per gram, at least 475 micrograms calcium per gram, and/or at least 200 micrograms magnesium per gram;
d) a CFS of a mixed microbial culture that has been diluted between 1:50 and 1:2000 with water; and/or
e) about 2% dry matter.

32. The method of any one of claims 22-24, wherein the composition comprises about 0.005-0.05% w/w CFS dry matter and/or about 0.5-5.0% w/w CFS.

33. The method of any one of claims 22-24, wherein the mycorrhizae comprise:
a) a combination of ectomycorrhizae and endomycorrhizae.
b) predominantly endomycorrhizae, optionally wherein the mycorrhizae comprise more than about 90% endomycorrhizae; and/or
c) 100-10,000 spores/gram.

34. The method of any one of claims 22-24, wherein the composition comprises about 0.5-5.0% mycorrhizae and/or 500-500,000 spores of mycorrhizae per kg of composition.

35. The method of any one of claims 22-24, wherein the composition comprises a diazotrophic bacterium, optionally wherein the composition comprises a symbiotic diazotrophic bacterium.

36. The method of any one of claims 22-24, wherein the composition comprises a bacterium of a genus selected from the list consisting of: Anabaena, Azoarcus, Azorhizobium, Azospirillum, Azotobacter, Bacillus, Bradyrhizobium, Burkholderia, Clostridium, Frankia, Gluconacetobacter, Herbaspirillum, Klebsiella, Mesorhizobium, Nitrosospira, Nostoc, Paenibacillus, Parasponia, Pseudomonas, Rhizobium, Rhodobacter, Sinorhizobium, Spirillum, and Xanthomonus, optionally wherein the composition comprises a bacterium of the genus Azospirillum, Bradyrhizobium, or Rhizobium.

37. The method of any one of claims 22-24, wherein the agricultural crop is:
a) a monocot or dicot; and/or
b) selected from the list consisting of agronomical crops, horticultural crops, and ornamental crops.

38. The method of any one of claims 22-24, wherein the method results in an increase in a growth, production, or biostimulant parameter of the agricultural crop in comparison to a control agricultural crop without the composition, optionally wherein the parameter is selected from the group consisting of: biomass, aerial biomass, number of roots, root biomass, number of secondary roots, uniformity of flowering, number of flowers, yield, number of fruits, productivity, chlorophyl content, carotenoid profile, antioxidant response capacity, water absorption capacity, nutrient absorption, and degree of inoculation by diazotrophic bacteria.

39. The method of any one of claims 22-24, wherein the combination of the contents of the composition produces an improvement on a growth, production, or biostimulant parameter of the agricultural crop, optionally wherein the improvement is greater than that observed for any component alone.

40. The method of any one of claims 22-24, wherein the composition comprises a carrier, optionally wherein:
a) the carrier is a liquid carrier, optionally wherein the liquid carrier is water; or
b) the carrier is a solid carrier, optionally wherein the carrier makes up more than 80% of the composition.

41. The method of any one of claims 22-24, wherein the composition comprises a carrier, and wherein the carrier is a natural clay-based or mineral-based carrier, optionally wherein the composition comprises a carrier selected from the group consisting of clay, zeolite, dolomite, bentonite, leonardite, and attapulgite.

42. The method of any one of claims 22-24, wherein the composition is applied to plant parts of the agricultural crop, optionally wherein the plant parts are the seeds, seedlings, plant tissues, leaves, branches, stems, bulbs, tubers, roots, root hairs, rhizomes, cuttings, flowers, or fruits.

43. The method of any one of claims 22-24, wherein the composition is a liquid and is applied as a spray to the aerial biomass of the plant and/or as a soil treatment and/or wherein the method comprises applying 1-10 L of the composition per hectare of the agricultural crop.

44. The method of any one of claims 22-24, wherein the composition is a granule, and wherein the method comprises applying 5-15 kg of the composition per hectare of the agricultural crop and/or wherein the method comprises applying an amount of the composition sufficient to deliver 10,000 to 2,000,000 spores of mycorrhizae per hectare of the agricultural crop.

45. The method of any one of claims 22-24, wherein the method comprises applying the composition more than once.

46. The method of any one of claims 22-24, wherein the method comprises applying the composition at the time of planting.

47. The method of any one of claims 22-24, wherein the method comprises applying the composition pre-blooming and/or within thirty days of planting, sowing, or tillering.
